(19) United States
(12) Patent Application Publication
(10) Pub. No.: US 2011/0098177 A1
(43) Pub. Date: Apr. 28, 2011

(54) METHODS AND COMPOSITIONS OF PLANT MICRONUTRIENTS

(75) Inventor: Ibrahim Abou-Nemeh, Lake St. Louis, MO (US)

(73) Assignee: NOVUS INTERNATIONAL INC., St. Charles, MO (US)

(21) Appl. No.: 12/914,413

(22) Filed: Oct. 28, 2010

Related U.S. Application Data
(63) Continuation-in-part of application No. PCT/US2009/042384, filed on Apr. 30, 2009.
Application No. PCT/US2009/042384 is a continuation-in-part of application No. 11/691,658, filed on Mar. 27, 2007, now abandoned.
(60) Provisional application No. 61/049,103, filed on Apr. 30, 2008.
(60) Provisional application No. 60/786,753, filed on Mar. 28, 2006.

(51) Int. Cl. A01N 55/02

(52) U.S. Cl. 504/101; 504/190

(57) ABSTRACT

The present invention encompasses a method for providing a metal to a plant in a manner such that a marketable yield trait of the plant is increased.

### CROSS REFERENCE TO RELATED APPLICATIONS

This application is a continuation in part of PCT/US2009/042384, filed Apr. 30, 2009, which claims the priority of U.S. provisional application No. 61/049,103, filed Apr. 30, 2008; and is a continuation in part of U.S. application Ser. No. 11/691,658, filed Mar. 27, 2007, which claims the priority of U.S. provisional application No. 60/786,753, filed Mar. 28, 2006, each of which is hereby incorporated by reference in their entirety.

### FIELD OF THE INVENTION

The invention encompasses methods and compositions for providing a metal micronutrient to a plant.

### BACKGROUND OF THE INVENTION

Plants must obtain their vital micronutrients, such as essential metals, by absorption from air, water and/or soil. If a plant lacks a micronutrient it requires, its development or production may be affected, resulting in lower yields. A plant suffering from micronutrient malnutrition may appear healthy, but the growth of the plant and/or quality and quantity of the crop may be adversely affected. This may result in large economic losses.

Although many soils contain sufficient micronutrients to sustain optimal growth, the micronutrients are often in a form that the plant cannot utilize. The positively charged metal ions are frequently absorbed by soil particles, forming insoluble solid metal hydroxides. Plants cannot separate the metals from the hydroxides, and thus, the metal micronutrient is lost to them.

One solution is to supply plants with metal compounds that resist forming such hydroxides, such as chelates. Chelates generally comprise a metal and a ligand that holds the metal in a bioavailable form that a plant can use. Depending on the ligand, however, some metal chelates can be toxic to plants. Additionally, some ligands may hold the metal in a more bioavailable form than other ligands. The more bioavailable the metal is, the less chelate is required for the same effect on plant development or growth. This can be an important cost consideration. Some chelates may have the added advantage of reducing insect damage to a plant. Consequently, there is a need for compositions of bioavailable micronutrients, such as metals, that are non-toxic to plants.

### SUMMARY OF THE INVENTION

Accordingly, one aspect of the invention encompasses a method for increasing a marketable yield trait of a plant. The method includes administering to the plant at least one compound that includes a chelate of a metal and a compound of formula (I):

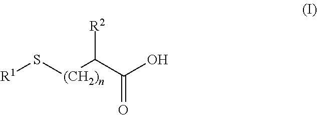

where n is an integer from 0 to 2, R¹ is methyl or ethyl, and R² is hydroxyl or amino. The amount of the compound administered to the plant increases at least one marketable yield trait of the plant without causing substantial foliar toxicity.

Another aspect of the invention encompasses a method for providing a micronutrient to a plant. The method includes coating a seed of the plant or soaking the seed in a solution with at least one compound that includes a chelate of a metal and a compound of formula (I), as above, where n is an integer from 0 to 2, R¹ is methyl or ethyl, and R² is hydroxyl or amino. In addition, the method includes incubating the seed under conditions such that the seed germinates. The amount of the compound coated on the seed or soaked into the seed provides the micronutrient to the plant as it grows in a manner that is non-toxic to the plant.

Other aspects and iterations of the invention are described more thoroughly below.

### DETAILED DESCRIPTION OF THE INVENTION

The present invention provides compositions and methods for providing a metal micronutrient to a plant and increasing a marketable yield trait of the plant. In particular, the present invention provides compositions comprising at least one metal compound and a fertilizer. Generally speaking, the methods comprise administering to the plant a metal compound. As illustrated in the Examples, at least one marketable yield trait of the plant is increased.

### I. Compositions

One aspect of the present invention encompasses a composition that may be utilized to provide a micronutrient to a plant or reduce insect damage to a plant. Typically, a composition of the invention comprises at least one metal compound and at least one fertilizer. A metal compound, however, may be administered alone to a plant to provide a metal micronutrient. A composition may also comprise an insecticide, microbicide, and/or a herbicide. Suitable metal compounds, fertilizers, and other components of a composition are detailed below.

In one embodiment, a composition may comprise at least one metal compound and at least one fertilizer in a single component. In another embodiment, a composition of the invention may comprise more than one component. For instance, a composition may comprise a metal compound component and a fertilizer component. If a composition comprises more than one component, then the separate components may be applied sequentially or simultaneously. More details on the application of a composition may be found in section II below.

### (a) Metal Compounds

Metal compounds of the invention may comprise metal chelates or metal salts. Each is described in more detail below. Typically, a metal compound may be administered to provide a metal micronutrient to a plant or to reduce insect damage to the plant. The metal compound may be administered alone, or in a composition of the invention, as herein described.

i. Metal Chelates

One embodiment of the invention provides compositions that include a metal chelate. Such chelates usually comprise an organic acid moiety and an organic sulfur moiety. In an exemplary embodiment, the chelate comprises a hydroxy analog of methionine. In one embodiment, the hydroxy analog of methionine is a compound having formula (I):

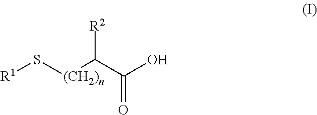

wherein:

n is an integer from 0 to 2;

R¹ is methyl or ethyl; and

R² is hydroxyl or amino.

In certain embodiments, when R¹ is methyl, R² is not an amino. In another exemplary embodiment for compounds having formula (I), n is 2, R¹ is methyl and R² is hydroxyl. The compound formed by this selection of chemical groups is 2-hydroxy-4(methylthio)butanoic acid (commonly known as “HMTBA” and sold by Novus International, St. Louis, Mo. under the trade name AMET®). A variety of HMTBA salts, chelates, esters, amides, and oligomers are also suitable for use in the invention. Representative esters of HMTBA include the methyl, ethyl, 2-propyl, butyl, and 3-methylbutyl esters of HMTBA. Representative amides of HMTBA include methylamide, dimethylamide, ethylmethylamide, butylamide, dibutylamide, and butylmethylamide. Representative oligomers of HMTBA include its dimers, trimers, tetramers and oligomers that include a greater number of repeating units.

Typically, the hydroxy analog of methionine forms a chelate comprising one or more ligand compounds having formula (I) together with one or more metal ions. Irrespective of the embodiment, suitable non-limiting examples of metal ions include zinc ions, copper ions, manganese ions, iron ions, chromium ions, cobalt ions, and calcium ions. In one embodiment, the metal ion is divalent. Examples of divalent metal ions (i.e., ions having a net charge of 2⁺) include copper ions, manganese ions, chromium ions, calcium ions, cobalt ions and iron ions. In another embodiment, the metal ion is zinc. In yet another embodiment, the metal ion is copper. In still another embodiment, the metal ion is manganese. In a further embodiment, the metal ion is iron. In each embodiment, the ligand compound having formula (I) is preferably HMTBA. In one exemplary embodiment, the metal chelate is Mn-HMTBA. In a further exemplary embodiment, the metal chelate is Cu-HMTBA. In an alternative exemplary embodiment, the metal chelate is Zn-HMTBA.

In one exemplary embodiment, the composition of the invention provides metal ion chelates that are effective for providing a metal micronutrient to a plant, and for reducing insect damage to a plant, and yet, minimize the degree of phytotoxicity for the plant itself. Generally speaking, metal ions may be toxic to plants, and their use generally carries the risk of injuring foliage and fruit of the plant in order to achieve the benefits. One factor underlying the extent of plant injury is the amount of actual metal administered to the plant in a given application. Because the metal-containing compounds of the invention are chelates, such as Cu-HMTBA, that are relatively stable and release ions over a relatively prolonged duration of time, the compounds may be formulated for controlled release applications. In this manner, the amount of metal ion administered to the plant in any given application may be significantly lower (i.e., minimizing the risk of damage to the plant), while the total amount of metal ion administered over time may be enough to provide the desired benefits. The metal-containing compounds of the invention may be formulated for controlled release according to methods generally known in the art.

In an additional exemplary embodiment, certain metal chelate compounds of the invention provide a source of “fixed” copper compounds. In this context, “fixed copper” refers to a form of copper compound in which the copper is in a chelated or complexed form. The resultant chemical is relatively insoluble compared to other copper compounds, such as copper sulfate. In an exemplary embodiment, for example, Cu-HMTBA and mixtures including this compound as well as Zn-HMBTA, may be used in applications suitable for use of fixed copper. An exemplary formulation for this application is for dusting plants with a powder containing the copper-containing compound. Formulations for powder may be accomplished by methods generally known in the art.

As will be appreciated by a skilled artisan, the ratio of ligands to metal ions forming a metal chelate compound can and will vary. Generally speaking, where the number of ligands is equal to the charge of the metal ions, the charge of the molecule is typically net neutral because the carboxy moieties of the ligands having formula (I) are in deprotonated form. By way of further example, in a chelate species where the metal ion carries a charge of 2⁺ and the ligand to metal ion ratio is 2:1, each of the hydroxyl or amino groups (i.e., R² of compound I) is believed to be bound by a coordinate covalent bond to the metal while an ionic bond exists between each of the carboxylate groups of the metal ion. This situation exists, for example, where divalent zinc, copper, or manganese is complexed with two HMTBA ligands. By way of further example, where the number of ligands exceeds the charge on the metal ion, such as in a 3:1 chelate of a divalent metal ion, the ligands in excess of the charge generally remain in a protonated state to balance the charge. Conversely, where the positive charge on the metal ion exceeds the number of ligands, the charge may be balanced by the presence of another anion, such as, for example, chloride, bromide, iodide, bicarbonate, hydrogen sulfate, and dihydrogen phosphate.

Generally speaking, a suitable ratio of ligand to metal ion is from about 1:1 to about 3:1 or higher. In another embodiment, the ratio of ligand to metal ion is from about 1.5:1 to about 2.5:1. Of course within a given mixture of metal chelate compounds, the mixture will include compounds having different ratios of ligand to metal ion. For example, a composition of metal chelate compounds may have species with ratios of ligand to metal ion that include 1:1, 1.5:1, 2:1, 2.5:1, and 3:1.

Metal chelate compounds of the invention may be made in accordance with methods generally known in the art, such as described in U.S. Pat. Nos. 4,335,257 and 4,579,962, which are both hereby incorporated by reference in their entirety. Alternatively, the metal chelate compounds may be purchased from a commercially available source. For example, Zn-HMTBA and Cu-HMTBA may be purchased from Novus International, Saint Louis, Mo., sold under the trade names MINTREX® Zn, and MINTREX® Cu, respectively.

The amount of metal chelate in a composition of the invention can and will vary. Generally speaking, the amount should be determined by the metal micronutrient needs of the plant. The micronutrient concentration of the soil used for the plant may also be taken into consideration. For more details, see Section II below.

ii. Metal Salts

In an alternative exemplary embodiment, the hydroxy analog of methionine may be a metal salt comprising an anionic compound having formula (I) together with a metal ion. Typically, suitable metal ions will have either a 1⁺, 2⁺or a 3⁺ charge and will be selected from zinc ions, copper ions, manganese ions, iron ions, chromium ions, nickel ions, and cobalt ions. Without being bound by any particular theory, however, it is generally believed that combinations of zinc, copper, manganese, iron, chromium, nickel, and cobalt ions together with HMTBA form metal chelates as opposed to salts. Irrespective of whether the molecule formed is a salt or a chelate, both forms of the molecules are included within the scope of the invention. Salts useful in the invention may be formed when the metal, metal oxide, metal hydroxide or metal salt (e.g., metal carbonate, metal nitrate, or metal halide) react with one or more compounds having formula (I). In an exemplary embodiment, the compound having formula (I) will be HMTBA. Salts may be prepared according to methods generally known in the art. For example, a metal salt may be formed by contacting HMTBA with a metal ion source.

The amount of metal salt in a composition of the invention can and will vary. Generally speaking, the amount should be determined by the metal micronutrient needs of the plant. The micronutrient concentration of the soil used for the plant may also be taken into consideration. For more details, see Section II below.

iii. Combinations of Metal Compounds

In certain embodiments, a composition of the invention may comprise more than one metal compound. For instance, a composition may comprise at least one metal chelate and at least one metal salt. In some embodiments, a composition may comprise at least two metal chelates. In other embodiments, a composition may comprise at least three metal chelates. In each of the above embodiments, the metal compound preferably comprises a chelate of formula (I), as detailed above. In an exemplary embodiment, the metal compound preferable comprises HMTBA. In one embodiment, a composition may comprise a metal compound combination detailed in Table A below.

The ratio of one metal compound to another in a combination of the invention can and will vary. Generally speaking, the ratio is determined by the metal micronutrient needs of the plant. The micronutrient concentration of the soil used for the plant may also be taken into consideration. For more details, see Section II below.

TABLE A
Combinations of metal compounds

| First metal | |
|---|---|
| compound | Additional metal compound |
| Zn-HMTBA chelate | At least one other micronutrient metal chelate |
| Zn-HMTBA chelate | Iron chelate |
| Zn-HMTBA chelate | Mn-HMTBA chelate |
| Zn-HMTBA chelate | Cu-HMTBA chelate |
| Zn-HMTBA chelate | Mn-HMTBA chelate and Cu-HMTBA chelate |
| Zn-HMTBA chelate | Mn-HMTBA chelate, Cu-HMTBA chelate, and iron chelate |
| Mn-HMTBA chelate | At least one other micronutrient metal chelate |
| Mn-HMTBA chelate | Iron chelate |
| Mn-HMTBA chelate | Zn-HMTBA chelate |
| Mn-HMTBA chelate | Cu-HMTBA chelate |
| Mn-HMTBA chelate | Zn-HMTBA chelate and Cu-HMTBA chelate |
| Mn-HMTBA chelate | Zn-HMTBA chelate, Cu-HMTBA chelate, and iron chelate |
| Cu-HMTBA chelate | At least one other micronutrient metal chelate |
| Cu-HMTBA chelate | Iron chelate |
| Cu-HMTBA chelate | Mn-HMTBA chelate |
| Cu-HMTBA chelate | Zn-HMTBA chelate |
| Cu-HMTBA chelate | Mn-HMTBA chelate and Zn-HMTBA chelate |
| Cu-HMTBA chelate | Zn-HMTBA chelate, Mn-HMTBA chelate, and iron chelate |
| Fe-HMTBA chelate | At least one other micronutrient metal chelate |
| Fe-HMTBA chelate | Mn-HMTBA chelate |
| Fe-HMTBA chelate | Zn-HMTBA chelate |
| Fe-HMTBA chelate | Mn-HMTBA chelate and Zn-HMTBA chelate |
| Ca-HMTBA chelate | At least one other micronutrient metal chelate |
| Ca-HMTBA chelate | Iron chelate |
| Ca-HMTBA chelate | Mn-HMTBA chelate |
| Ca-HMTBA chelate | Cu-HMTBA chelate |
| Ca-HMTBA chelate | Mn-HMTBA chelate and Cu-HMTBA chelate |
| Ca-HMTBA chelate | Mn-HMTBA chelate, Cu-HMTBA chelate, and iron chelate |

### (b) Fertilizers

A composition of the invention typically comprises at least one fertilizer in addition to at least one metal compound. As used herein, fertilizer refers to a composition capable of providing nutrition to a plant. For instance, a fertilizer may provide, in varying proportions, the three primary plant nutrients (also called macronutrients): nitrogen, phosphorus, and potassium. The macronutrients are consumed in larger quantities and may be present as a whole number or tenths of percentages in plant tissues (on a dry matter weight basis). Alternatively or additionally, the fertilizer may provide secondary plant nutrients such as calcium, sulfur, or magnesium. Moreover, a fertilizer may provide a trace element (or micronutrient) such as boron, chlorine, and molybdenum. Micronutrients may be required in concentrations ranging from 5 to 100 parts per million (ppm) by mass.

Fertilizers may be artificial or naturally occurring. Non-limiting examples of naturally occurring fertilizers may include manure, slurry, worm castings, peat, seaweed, sewage, mine rock phosphate, sulfate of potash, limestone and guano. Fertilizers may also include conventional fertilizer source materials that contain phosphorous, potassium or nitrogen. The amounts of available nitrogen, phosphorous and potassium may be varied in accordance with the requirements of the plants to be fertilized. Conventional fertilizer percentages (i.e., the mass ratio of N:P:K) including but not limited to 16:8:8; 8:4:4; 5:5:5; 15:5:5 and 22:11:11 may be provided by a fertilizer of the invention. Urea, ammonium sulfate, mono-ammonium phosphate or other known sources of nitrogen may be used alone or in mixtures as the source of nitrogen. Diammonium phosphate may be used as a source of both nitrogen and phosphorous. Alternately, mono-ammonium phosphate, super phosphate, or triple super phosphate, a phosphate rock containing three times as much phosphoric acid as super phosphate, may be used as the source of phosphorous. Potassium chloride, potassium sulfate or other potassium salt may be used to provide the potash. Trace elements and secondary nutrients such as calcium, magnesium and sulfur may be included in the mixture, if desired. The trace elements may include iron, copper, manganese, barium, zinc, chlorine, vanadium, selenium, sodium, molybdenum or any other element required by a plant.

Suitable fertilizers may be in the form of a powder, a granule, a liquid, or a nutritionally enriched soil. Methods of making various fertilizer forms are well known in the art. The ratio of fertilizer to metal compound(s) in a composition of the invention can and will vary. In some embodiments, the ratio of fertilizer to metal compound(s) is about 1:1, 1:2, 1:3, 1:4, 1:5, 1:6, 1:7, 1:8, 1:9, or 1:10. In other embodiments, the ratio is about 2:1, 3:1, 4:1, 5:1, 6:1, 7:1, 8:1, 9:1, or 10:1.

### (c) Other Components

Yet another aspect of the invention provides compositions comprising insecticides, microbicides, herbicides, plant-growth regulators and other components. In some cases, synergism can be expected from the use of the compositions of this invention. Usually, the other components of a composition of the invention will not exceed about 50% of the composition. In some embodiments, the other components will not exceed about 10%, 15%, 20%, 25%, 30%, 35%, 40%, or 45% of the composition.

i. Microbicides

In one embodiment, a composition of the invention may comprise a microbicide. Suitable microbicides may include a fungicide or a bactericide. As will be appreciated by a skilled artisan, the choice of a fungicide or bactericide can and will vary depending upon the plant and the microbial target. Suitable non-limiting examples of fungicides and bactericides that may be used include the following: carbamate fungicides such as 3,3′-ethylenebis(tetrahydro-4,6-dimethyl-2H-1,3,5-thiadiazine-2-thione), zinc or manganese ethylenebis(dithiocarbamate), bis(dimethyldithiocarbamoyl)disulfide, zinc propylenebis(dithiocarbamate)bis(dimethyldithiocarbamoyl)ethylenediamine; nickel dimethyldithiocarbamate, methyl 1-(butylcarbamoyl)-2-benzimidazolecarbamate, 1,2-bis(3-methoxycarbonyl-2-thioureido)benzene, 1-isopropylcarbamoyl-3-(3,5-dichlorophenyl)hydantoin, potassium N-hydroxymethyl-N-methyldithiocarbamate and 5-methyl-10-butoxycarbonylamino-10,11-dehydrodibenzo (b,f)azepine; pyridine fungicides such as zinc bis(1-hydroxy-2(1H)pyridinethionate) and 2-pyridinethiol-1-oxide sodium salt; phosphorus fungicides such as O,O-diisopropyl S-benzylphosphorothioate and O-ethyl S,S-diphenyldithiophosphate; phthalimide fungicides such as N-(2,6-diethylphenyl)phthalimide and N-(2,6-diethylphenyl)-4-methylphthalimide; dicarboxyimide fungicides such as N-trichloromethylthio-4-cyclohexene-1,2-dicarboxyimide and N-tetrachloroethylthio-4-cyclohexene-1,2-dicarboxyimide; oxathine fungicides such as 5,6-dihydro-2-methyl-1,4-oxathine-3-carboxanilido-4,4-dioxide and 5,6-dihydro-2-methyl-1,4-oxathine-3-carboxanilide; naphthoquinone fungicides such as 2,3-dichloro-1,4-naphthoquinone, 2-oxy-3-chloro-1,4-naphthoquinone copper sulfate; pentachloronitrobenzene; 1,4-dichloro-2,5-dimethoxybenzene; 5-methyl-s-triazol(3,4-b)benzthiazole; 2-(thiocyanomethylthio)benzothiazole; 3-hydroxy-5-methylisooxazole; N-2,3-dichlorophenyltetrachlorophthalamic acid; 5-ethoxy-3-trichloromethyl-1-2,4-thiadiazole; 2,4-dichloro-6-(O-chloroanilino)-1,3,5-triazine; 2,3-dicyano-1,4-dithioanthraquinone; copper 8-quinolinate, polyoxine; validamycin; cycloheximide; iron methanearsonate; diisopropyl-1,3-dithiolane-2-iridene malonate; 3-allyloxy-1,2-benzoisothiazol-1,1-dioxide; kasugamycin; Blasticidin S; 4,5,6,7-tetrachlorophthalide; 3-(3,5-dichlorophenyl)-5-ethenyl-5-methyloxazolizine-2,4-dione; N-(3,5-dichlorophenyl)-1,2-dimethylcyclopropane-1,2-dicarboxyimide; S-n-butyl-5′-para-t-butylbenzyl-N-3-pyridyldithiocarbonylimidate; 4-chlorophenoxy-3,3-dimethyl-1-(1H,1,3,4-triazol-1 -yl)-2-butanone; methyl-D,L-N-(2,6-dimethylphenyl)-N-(2′-methoxyacetyl)alaninate; N-propyl-N-[2-(2,4,6-trichlorophenoxy)ethyl]imidazol-1-carboxamide; N-(3,5-dichlorophenyl)succinimide; tetrachloroisophthalonitrile; 2-dimethylamino-4-methyl-5-n-butyl-6-hydroxypyrimidine; 2,6-dichloro-4-nitroaniline; 3-methyl-4-chlorobenzthiazol-2-one; 1,2,5,6-tetrahydro-4H-pyrrolo[3,2,1-i,j]quinoline-2-one; 3′-isopropoxy-2-methylbenzanilide; 1-[2-(2,4-dichlorophenyl)-4-ethyl-1,3-dioxorane-2-ylmethyl]-1H,1,2,4-triazol; 1,2-benzisothiazoline-3-one; basic copper chloride; basic copper sulfate; N′-dichlorofluoromethylthio-N,N-dimethyl-N-phenylsulfamide; ethyl-N-(3-dimethylaminopropyl)thiocarbamate hydrochloride; piomycin; S,S-6-methylquinoxaline-2,3-diyldithiocarbonate; complex of zinc and manneb; di-zinc bis(dimethyldithiocarbamate) ethylenebis (dithiocarbamate) and glyphosate. Additional suitable fungicides may include a chlorothalonil-based fungicide, a strobilurin-based fungicide, a triazole-based fungicide or a suitable combination of these fungicides. Non-limiting examples of suitable strobilurin-based fungicides include azoxystrobin, pyraclostrobin, or trifloxystrobin. Representative examples of triazole-based fungicides include myclobutanil, propiconazole, tebuconazol, and tetraconazole.

ii. Herbicides

In another embodiment, a composition of the invention may comprise an herbicide. Non-limiting examples of herbicides that may be used include, without limitation, imidazolinone, acetochlor, acifluorfen, aclonifen, acrolein, AKH-7088, alachlor, alloxydim, ametryn, amidosulfuron, amitrole, ammonium sulfamate, anilofos, asulam, atrazine, azafenidin, azimsulfuron, BAS 620H, BAS 654 00H, BAY FOE 5043, benazolin, benfluralin, benfuresate, bensulfuron-methyl, bensulide, bentazone, benzofenap, bifenox, bilanafos, bispyribac-sodium, bromacil, bromobutide, bromofenoxim, bromoxynil, butachlor, butamifos, butralin, butroxydim, butylate, cafenstrole, carbetamide, carfentrazone-ethyl, chlormethoxyfen, chloramben, chlorbromuron, chloridazon, chlorimuron-ethyl, chloroacetic acid, chlorotoluron, chlorpropham, chlorsulfuron, chlorthal-dimethyl, chlorthiamid, cinmethylin, cinosulfuron, clethodim, clodinafop-propargyl, clomazone, clomeprop, clopyralid, cloransulam-methyl, cyanazine, cycloate, cyclosulfamuron, cycloxydim, cyhalofop-butyl, 2,4-D, daimuron, dalapon, dazomet, 2,4DB, desmedipham, desmetryn, dicamba, dichlobenil, dichlorprop, dichlorprop-P, diclofop-methyl, difenzoquat metilsulfate, diflufenican, dimefuron, dimepiperate, dimethachlor, dimethametryn, dimethenamid, dimethipin, dimethylarsinic acid, dinitramine, dinocap, dinoterb, diphenamid, diquat dibromide, dithiopyr, diuron, DNOC, EPTC, esprocarb, ethalfluralin, ethametsulfuron-methyl, ethofumesate, ethoxysulfuron, etobenzanid, fenoxaprop-P-ethyl, fenuron, ferrous sulfate, flamprop-M, flazasulfuron, fluazifop-butyl, fluazifop-P-butyl, fluchloralin, flumetsulam, flumiclorac-pentyl, flumioxazin, fluometuron, fluoroglycofen-ethyl, flupoxam, flupropanate, flupyrsulfuron-methyl-sodiu-m, flurenol, fluridone, flurochloridone, fluroxypyr, flurtamone, fluthiacet-methyl, fomesafen, fosamine, glufosinate-ammonium, glyphosate, glyphosinate, halosulfuron-methyl, haloxyfop, HC-252, hexazinone, imazamethabenz-methyl, imazamox, imazapyr, imazaquin, imazethapyr, imazosuluron, imidazilinone, indanofan, ioxynil, isoproturon, isouron, isoxaben, isoxaflutole, lactofen, lenacil, linuron, MCPA, MCPA-thioethyl, MCPB, mecoprop, mecoprop-P, mefenacet, metamitron, metazachlor, methabenzthiazuron, methylarsonic acid, methyldymron, methyl isothiocyanate, metobenzuron, metobromuron, metolachlor, metosulam, metoxuron, metribuzin, metsulfuron-methyl, molinate, monolinuron, naproanilide, napropamide, naptalam, neburon, nicosulfuron, nonanoic acid, norflurazon, oleic acid (fatty acids), orbencarb, oryzalin, oxadiargyl, oxadiazon, oxasulfuron, oxyfluorfen, paraquat dichloride, pebulate, pendimethalin, pentachlorophenol, pentanochlor, pentoxazone, petroleum oils, phenmedipham, picloram, piperophos, pretilachlor, primisulfuron-methyl, prodiamine, prometon, prometryn, propachlor, propanil, propaquizafop, propazine, propham, propisochlor, propyzamide, prosulfocarb, prosulfuron, pyraflufen-ethyl, pyrazolynate, pyrazosulfuron-ethyl, pyrazoxyfen, pyributicarb, pyridate, pyriminobac-methyl, pyrithiobac-sodium, quinclorac, quinmerac, quinoclamine, quizalofop, quizalofop-P, rimsulfuron, sethoxydim, siduron, simazine, simetryn, sodium chlorate, STS system (sulfonylurea), sulcotrione, sulfentrazone, sulfometuron-methyl, sulfosulfuron, sulfuric acid, tar oils, 2,3,6-TBA, TCA-sodium, tebutam, tebuthiuron, terbacil, terbumeton, terbuthylazine, terbutryn, thenylchlor, thiazopyr, thifensulfuron-methyl, thiobencarb, tiocarbazil, tralkoxydim, tri-allate, triasulfuron, triaziflam, tribenuron-methyl, triclopyr, trietazine, trifluralin, triflusulfuron-methyl, and vernolate.

iii. Insecticides

In still another embodiment, a composition of the invention may comprise an insecticide. Representative examples of suitable insecticides may include the following: phosphoric insecticides such as O,O-diethyl O-(2-isopropyl-4-methyl-6-pyrimidinyl)phosphorothioate, O,O-dimethyl S-2-[(ethylthio)ethyl]phosphorodithioate, O,O-dimethyl O-(3-methyl-4-nitrophenyl)thiophosphate, O,O-dimethyl S—(N-methylcarbamoylmethyl)phosphorodithioate, O,O-dimethyl S—(N-methyl-N-formylcarbamoylmethyl)phosphorodithioate, O,O-dimethyl S-2-[(ethylthio)ethyl]phosphorodithioate, O,O-diethyl S-2-[(ethylthio)ethyl]phosphorodithioate, O,O-dimethyl-1-hydroxy-2,2,2-trichloroethylphophonate, O,O-diethyl-O-(5-phenyl-3-isooxazolyl)phosphorothioate, O,O-dimethyl O-(2,5-dichloro-4-bromophenyl)phosphorothioate, O,O-dimethyl O-(3-methyl-4-methylmercaptophenyl)thiophosphate, O-ethyl O-p-cyanophenyl phenylphosphorothioate, O,O-dimethyl-S-(1,2-dicarboethoxyethyl)phosphorodithioate, 2-chloro-(2,4,5-trichlorophenyl)vinyldimethyl phosphate, 2-chloro-1-(2,4-dichlorophenyl)vinyldimethyl phosphate, O,O-dimethyl O-p-cyanophenyl phosphorothioate, 2,2-dichlorovinyl dimethyl phosphate, O,O-diethyl O-2,4-dichlorophenyl phosphorothioate, ethyl mercaptophenylacetate O,O-dimethyl phosphorodithioate, S-[(6-chloro-2-oxo-3-benzooxazolinyl)methyl]O,O-diethyl phosphorodithioate, 2-chloro-1-(2,4-dichlorophenyl)vinyl diethylphosphate, O,O-diethyl O-(3-oxo-2-phenyl-2H-pyridazine-6-yl)phosphorothioate, O,O-dimethyl S-(1-methyl-2-ethylsulfinyl)-ethyl phophorothiolate, O,O-dimethyl S-phthalimidomethyl phosphorodithioate, O,O-diethyl S—(N-ethoxycarbonyl-N-methylcarbamoylmethyl)phosphorodithioate, O,O-dimethyl S-[2-methoxy-1,3,4-thiadiazol-5-(4H)-onyl-(4)-methyl]dithiophosphate, 2-methoxy-4H-1,3,2-benzooxaphosphorine 2-sulfide, O,O-diethyl O-(3,5,6-trichloro-2-pyridyl)phosphorothiate, O-ethyl O-2,4-dichlorophenyl thionobenzene phosphonate, S-[4,6-diamino-s-triazine-2-yl-methyl]O,O-dimethyl phosphorodithioate, O-ethyl O-p-nitrophenyl phenyl phosphorothioate, O,S-dimethyl N-acetyl phosphoroamidothioate, 2-diethylamino-6-methylpyrimidine-4-yl-diethylphosphorothionate, 2-diethylamino-6-methylpyrimidine-4-yl-dimethylphosphorothionate, O,O-diethyl O—N-(methylsulfinyl)phenyl phosphorothioate, O-ethyl S-propyl O-2,4-dichlorophenyl phosphorodithioate and cis-3-(dimethoxyphosphinoxy)N-methyl-cis-crotone amide; carbamate insecticides such as 1-naphthyl N-methylcarbamate, S-methyl N-[methylcarbamoyloxy]thioacetoimidate, m-tolyl methylcarbamate, 3,4-xylyl methylcarbamate, 3,5-xylyl methylcarbamate, 2-sec-butylphenyl N-methylcarbamate, 2,3-dihydro-2,2-dimethyl-7-benzofuranylmethylcarbamate, 2-isopropoxyphenyl N-methylcarbamate, 1,3-bis(carbamoylthio)-2-(N,N-dimethylamino)propane hydrochloride and 2-diethylamino-6-methylpyrimidine-4-yl-dimethylcarbamate; and other insecticides such as N,N-dimethyl N′-(2-methyl-4-chlorophenyl)formamidine hydrochloride, nicotine sulfate, milbemycin, 6-methyl-2,3-quinoxalinedithiocyclic S,S-dithiocarbonate, 2,4-dinitro-6-sec-butylphenyl dimethylacrylate, 1,1-bis(p-chlorophenyl) 2,2,2-trichloroethanol, 2-(p-tert-butylphenoxy)isopropyl-2′-chloroethylsulfite, azoxybenzene, di-(p-chlorophenyl)-cyclopropyl carbinol, di[tri(2,2-dimethyl-2-phenylethyl)tin]oxide, 1-(4-chlorophenyl)-3-(2,6-difluorobenzoyl) urea and S-tricyclohexyltin O,O-diisopropylphosphorodithioate.

### (d) Formulations

It is envisioned that components listed above may be combined with one or more agents that are conventionally employed in the formulation of agricultural and horticultural compositions. The compositions of this invention, including concentrates that require dilution prior to application, typically may contain at least one metal compound and an adjuvant in liquid or solid form. The compositions may be prepared by admixing the components with or without an adjuvant plus diluents, extenders, carriers, and conditioning agents to provide compositions in the form of wettable powder, soluble powder, dust, aerosol, microcapsules, finely-divided particulate solids, granules, pellets, solutions, seed coatings, dispersions or emulsions. In one embodiment, a composition will be in the form of a dust or powder for use in dusting the plant with a composition of the invention, such as by crop dusting. In another embodiment, the components may be mixed with an adjuvant such as a finely divided solid, a liquid of organic origin, water, a wetting agent, a dispersing agent, an emulsifying agent, a spreader, a sticker, a thickening agent, or any suitable combination of these agents.

A variety of suitable solid, liquid, and gaseous carriers may be utilized in the compositions of the invention. Suitable solid carriers include, for example, fine powders or granules of clays (e.g. kaolin clay, diatomaceous earth, synthetic hydrated silicon dioxide, attapulgite clay, bentonite and acid clay), talcs, other inorganic minerals (e.g. sericite, powdered quartz, powdered sulfur, activated carbon, calcium carbonate and hydrated silica), and salts for chemical fertilizers (e.g. ammonium sulfate, ammonium phosphate, ammonium nitrate, urea and ammonium chloride). Suitable liquid carriers include, for example, water, alcohols (e.g. methanol and ethanol), ketones (e.g. acetone, methyl ethyl ketone and cyclohexanone), aromatic hydrocarbons (e.g. benzene, toluene, xylene, ethylbenzene and methylnaphthalene), aliphatic hydrocarbons (e.g. hexane and kerosene), esters (e.g. ethyl acetate and butyl acetate), nitriles (e.g. acetonitrile and isobutyronitrile), ethers (e.g. dioxane and diisopropyl ether), acid amides (e.g. dimethylformamide and dimethylacetamide), and halogenated hydrocarbons (e.g. dichloroethane, trichloroethylene and carbon tetrachloride). Suitable gaseous carriers include, for example, butane gas, carbon dioxide, and fluorocarbon gas.

In one embodiment, the formulation may include a wetting agent (i.e., also known as a surfactant or spreader). Typically, a suitable wetting agent will enhance the contact and uptake of the components of the composition by the plant via a variety of mechanisms such as by causing increased spreading and retention of the components. A variety of wetting agents of the cationic, anionic or non-ionic type may be used. Non-limiting examples of wetting agents suitable for use include alkyl benzene and alkyl naphthalene sulfonates, alkyl and alkyl aryl sulfonates, alkyl amine oxides, alkyl and alkyl aryl phosphate esters, organosilicones, fluoro-organic wetting agents, alcohol ethoxylates, alkoxylated amines, sulfated fatty alcohols, amines or acid amides, long chain acid esters of sodium isothionate, esters of sodium sulfosuccinate, sulfated or sulfonated fatty acid esters, petroleum sulfonates, sulfonated vegetable oils, ditertiary acetylenic glycols, block copolymers, polyoxyalkylene derivatives of alkylphenols (particularly isooctylphenol and nonylphenol) and polyoxyalkylene derivatives of the mono-higher fatty acid esters of hexitol anhydrides (e.g., sorbitan). Further examples may include ethoxylated sorbitan, ethoxylated fatty acid, polysorbate-80, glycerol oleate, oleate salts, coconate salts, laurelate salts and suitable combinations of any of these wetting agents. In one embodiment, the surfactant is a non-ionic surfactant.

In another embodiment, the composition may include a dispersant. Examples of dispersant include methyl, cellulose, polyvinyl alcohol, sodium lignin sulfonates, polymeric alkyl naphthalene sulfonates, sodium naphthalene sulfonate, polymethylene bisnaphthalene sulfonate, and neutralized polyoxyethylated derivatives or ring-substituted alkyl phenol phosphates. Stabilizers may also be used to produce stable emulsions, such as magnesium aluminum silicate and xanthan gum.

In another embodiment, the composition may include a sticker. Typically, a suitable sticker will increase the firmness of attachment of finely-divided solids or other water-soluble or water-insoluble materials to the solid surfaces of the plant such as leaves and stems, and which may be measured in terms of resistance to time, wind, water, mechanical or chemical action. Non-limiting examples of stickers include latex-based resins, beta-pinene, free fatty acids, alkanolamides, gum arabic, gum karaya, gum tragacanth, guar gum, locust bean gum, xanthan gum, carrageenan, alginate salt, casein, dextran, pectin, agar, 2-hydroxyethyl starch, 2-aminoethyl starch, 2-hydroxyethyl cellulose, methyl cellulose, carboxymethyl cellulose salt, cellulose sulfate salt, polyvinylpyrrolidone, polyethylene glycol, polyacrylamide, and gelatin.

In still another embodiment, the composition may include a thickening agent. Typically, a suitable thickening agent increases the viscosity of the composition. Non-limiting examples of suitable thickening agents include polyethylene glycols, glycerol, sodium carboxymethylcellulose, gelatin, pectin, zinc oxide, starch, bentonite, cellulose derivatives such as carboxymethyl cellulose, starches, gums, casein, gelatin, phycocolloids, polyvinyl alcohol, carboxyvinylates, silicates, colloidal silica, alginates, talc, magnesium aluminum silicate, xanthan gum, cornstarch, potato starch, soy starch, and wheat starch.

The active compounds may also be formulated as a spray in the form of an aerosol. When formulated as an aerosol spray, the formulation is generally charged in a container under pressure together with a propellant. Examples of suitable propellants include fluorotrichloromethane or dichlorodifluoromethane.

The active compounds may be formulated in the form of a seed coating that includes the active compounds as well as at least one coating agent. Typically, suitable seed coatings house ingredients to enhance seed propagation, as well as to protect the seeds from fungal infestation, pest insects, and damage during packaging, shipping and planting. Non-limiting examples of coating agents include polymers, such as acrylics, modified polyacrylamides, vinyl acrylics, a neutralized copolymer of acrylic acid (AA) or methacrylic acid (MAA) and a lower acrylate, a crosslinked copolymer of vinyl acetate and a lower alkyl acrylate, proteins, polysaccharides, polyesters, polyurethanes, polyvinyl alcohol, hydrolyzed polyvinyl acetates, polyvinyl methyl ether, polyvinyl methyl ether-maleic anhydride, and polyvinylpyrrolidone.

The seed coating may be formed using methods known in the art. For example, the active compounds may be mixed with an emulsion polymer, the emulsion polymer may be applied to the seed, and the polymer may be allowed to dry on the seed. The seed coating may be applied using known methods including but not limited to immersing the seeds in an emulsion polymer, spraying the seeds with the emulsion polymer, rotary drum coating, and coating using a fluidized bed apparatus such as a Wurster apparatus.

The amount of seed coating that is applied to a seed can and will vary depending in part on the number and amounts of active compounds incorporated into the seed coating, the size of the seed, and the desired material properties of the seed coating. The seed coating may be resistant to abrasion or fracture during manufacture, packaging, transport, and planting. In addition, the seed coating may be resistant to forming aggregated clumps of seeds during storage or planting. Further, the seed coating may be resistant to storage conditions such as heat or humidity.

However, the seed coating may also degrade when exposed to conditions conducive to germination once the seed is planted. In particular, the seed coating may degrade in such a way that the seed receives adequate oxygen, water, and nutrients to support germination and subsequent emergence. In addition, the seed coating may degrade in such a way that the growing shoot of the germinated seed may emerge from the seed. For example, the coating agent material may be water-permeable and may further swell and form pores, channels or other physical openings when exposed to moisture in an amount sufficient to support germination. In another example, the coating agent material may be susceptible to degradation only within a temperature range conducive to seed germination. The material properties of the seed coating can and will vary depending in part on the size and shape of the seed, the desired germination conditions, the coating agent, and the thickness and overall amount of the seed coating.

The thickness of the seed coating may be sufficiently thin to allow normal respiration and germination of the seed. In one embodiment, the thickness of the seed coating applied to a seed may vary between about 0.01 mm and about 5 mm. In other embodiments, the thickness of the seed coating may vary between about 0.01 mm and about 0.1 mm, about 0.05 mm and about 0.2 mm, about 0.1 mm and about 0.4 mm, about 0.2 mm and about 0.8 mm, about 0.5 mm and about 1.5 mm, about 1 mm and about 2 mm, about 1.5 mm and about 2.5 mm, about 2 mm and about 4 mm, and about 3 mm and about 5 mm. In another embodiment, the weight of the seed coating may vary between about 1% and about 100% of the weight of the uncoated seed. In other embodiments, the weight of the seed coating may vary between about 1% and about 10%, about 5% and about 20%, about 10% and about 30%, about 20% and about 40%, about 50% and about 70%, about 60% and about 80%, about 70% and about 90%, and about 80% and about 100% of the weight of the uncoated seed.

### II. Methods for Providing an Essential Metal

Another aspect of the invention is a method for providing an essential metal to a plant. Generally speaking, the method comprises administering to the plant an effective amount of at least one metal compound. In an exemplary embodiment, the method comprises administering an effective amount of at least one metal chelate, wherein the chelate comprises a compound of formula (I):

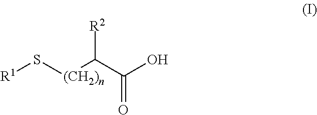

wherein:

n is an integer from 0 to 2;

R¹ is methyl or ethyl; and

R² is hydroxyl or amino.

In some embodiments of the method, when R¹ of formula (I) is methyl, R² is not an amino. In another exemplary embodiment of the method, n of formula (I) is 2, R¹ is methyl and R² is hydroxyl. Stated another way, the metal chelate is comprised of HMTBA.

In other embodiments, the method comprises administering to the plant an effective amount of a composition, as detailed in section I above.

Typically, an “effective amount” of a metal compound, as used herein, can and will vary depending in part on the metal compound, the plant, the soil composition, and the growing conditions. Generally speaking, no increase in growth or production of the plant will occur either below or above the effective amount. In addition, applications of the metal compound above the effective amount may be toxic to the plant, resulting in adverse effects including but not limited to foliar toxicity and decreased marketable yield.

As guidance for determining the effective amount, the metal nutrient needs of a plant may be calculated for a growing season using methods commonly known in the art. The calculated nutrient needs may then be used to calculate the effective amount. For instance, the effective amount of the metal compound will usually be about 10×, 9×, 8×, 7×, 6×, 5×, 4×, 3×, 2×, 1×, 0.75×, 0.5×, or 0.25× of the metal nutrient needs of the plant. In some embodiments, the metal micronutrient concentration of the soil may be considered in determining the effective amount.

In one embodiment, the compound may be applied as an aqueous solution. In this embodiment, the aqueous solution including the compound may be sprayed directly onto the soil, onto the seeds of the plant prior to planting, or onto the leaves and stem of the plant. The compound may be applied in a single application, or the compound may be applied in at least two applications. The concentration at which the compound may be administered in each application can and will vary depending in part on the metal compound, the plant, the soil composition and the growing conditions. In one embodiment, the compound may be applied in each application at a concentration ranging between about 10 ppm and about 50,000 ppm. In other embodiments, the compound may be applied in each application at concentrations ranging between about 20 ppm and about 45,000 ppm, between about 40 ppm and about 40,000 ppm, between about 40 ppm and about 30,000 ppm, between about 40 ppm and about 20,000 ppm, between about 40 ppm and about 10,000 ppm, between about 40 ppm and about 5,000 ppm, and between about 40 ppm and about 2500 ppm.

In another embodiment, if the compound is a Zn-HMTBA chelate, the compound may be applied in each application at a concentration ranging between about 30 ppm and about 3,000 ppm. In other embodiments, if the compound is a Zn-HMTBA chelate, the compound may be applied in each application at concentrations ranging between about 30 ppm and about 300 ppm, about 50 ppm and about 500 ppm, between about 100 ppm and about 600 ppm, between about 200 ppm and about 700 ppm, between about 300 ppm and about 800 ppm, between about 400 ppm and about 900 ppm, between about 500 ppm and about 1,000 ppm, and between about 750 ppm and about 1250 ppm, between about 1000 ppm and about 2000 ppm, between about 1500 ppm and about 2500 ppm, and between about 2000 ppm and about 3000 ppm.

In yet another embodiment, if the compound is a Cu-HMTBA chelate, the compound may be applied in each application at a concentration ranging between about 200 ppm and about 15,000 ppm. In other embodiments, if the compound is a Cu-HMTBA chelate, the compound may be applied in each application at concentrations ranging between about 200 ppm and about 1200 ppm, between about 500 ppm and about 1500 ppm, between about 1000 ppm and about 2000 ppm, between about 1500 ppm and about 2500 ppm, between about 2000 ppm and about 4000 ppm, between about 5000 ppm and about 7000 ppm, and between about 6000 ppm and about 8000 ppm, between about 7000 ppm and about 9000 ppm, between about 8000 ppm and about 10,000 ppm, between about 9000 ppm and about 11,000 ppm, between about 10,000 ppm and about 12,000 ppm, between about 11,000 ppm and about 13,000 ppm, between about 12,000 ppm and about 14,000 ppm and between about 13,000 ppm and about 15,000 ppm.

In yet another embodiment, if the compound is a Mn-HMTBA chelate, the compound may be applied in each application at a concentration ranging between about 1000 ppm and about 50,000 ppm. In other embodiments, if the compound is a Mn-HMTBA chelate, the compound may be applied in each application at concentrations ranging between about 1000 ppm and about 5000 ppm, between about 2500 ppm and about 7500 ppm, between about 5000 ppm and about 10,000 ppm, between about 7,500 ppm and about 12,500 ppm, between about 10,000 ppm and about 20,000 ppm, between about 15,000 ppm and about 25,000 ppm, and between about 20,000 ppm and about 30,000 ppm, between about 25,000 ppm and about 35,000 ppm, between about 30,000 ppm and about 40,000 ppm, between about 35,000 ppm and about 45,000 ppm, and between about 40,000 ppm and about 50,000 ppm.

In yet another embodiment, if the compound is a Fe-HMTBA chelate, the compound may be applied in each application at a concentration ranging between about 5000 ppm and about 15,000 ppm. In other embodiments, if the compound is a Fe-HMTBA chelate, the compound may be applied in each application at concentrations ranging between about 5000 ppm and about 6000 ppm, between about 5500 ppm and about 6500 ppm, between about 6000 ppm and about 7000 ppm, between about 6500 ppm and about 7500 ppm, between about 7000 ppm and about 8000 ppm, between about 7500 ppm and about 8500 ppm, between about 8000 ppm, and about 9000 ppm, between about 8500 ppm and about 9500 ppm, between about 9000 ppm and about 10,000 ppm, between about 9500 ppm and about 10,500 ppm, between about 10,000 ppm and about 12,000 ppm, between about 11,000 ppm and about 13,000 ppm, between about 12,000 ppm and about 14,000 ppm, and between about 13,000 ppm and about 15,000 ppm.

In yet another embodiment, if the compound is a Ca-HMTBA chelate, the compound may be applied in each application at a concentration ranging between about 20 ppm and about 500 ppm. In other embodiments, if the compound is a Ca-HMTBA chelate, the compound may be applied in each application at concentrations ranging between about 20 ppm and about 80 ppm, between about 50 ppm and about 100 ppm, between about 70 ppm and about 150 ppm, between about 100 ppm and about 200 ppm, between about 150 ppm and about 250 ppm, between about 200 ppm and about 300 ppm, and between about 250 ppm and about 350 ppm, between about 300 ppm and about 400 ppm, between about 350 ppm and about 450 ppm, and between about 400 ppm and about 500 ppm.

In one exemplary embodiment, for a tomato plant, a Zn-HMTBA chelate may be administered at about 45.0 to about 500 mg/plant/season, a Cu-HMTBA chelate may be administered at about 300.0 to about 1500.0 mg/plant/season, and an Mn-HMTBA chelate may be administered at about 200.0 to about 3400.0 mg/plant/season. In another exemplary embodiment, for a pepper plant, a Zn-HMTBA chelate may be administered at about 10.0 to about 65.0 mg/plant/season, a Cu-HMTBA chelate may be administered at about 50.0 to about 375.0 mg/plant/season, and an Mn-HMTBA chelate may be administered at about 350.0 to about 900.0 mg/plant/season.

A method of the invention may comprise administering at least two, at least three, or at least four metal compounds to a plant. In some embodiments, a method of the invention may comprise administering a combination of metal compounds detailed in Table A above.

Methods of measuring the effectiveness of a metal compound in delivering a metal micronutrient to a plant are detailed in the Examples. For instance, the foliar nutrient concentration of the plant may be determined, using methods commonly known in the art, before and after application of the metal compound. Alternatively, the marketable yield for a plant provided the metal compound may be compared to a similarly situated plant that was not provided the metal compound. As used herein, “marketable yield trait” refers to the product or attribute of the plant affected by the metal compound. For instance, marketable yield trait may refer to an increase in harvestable grain, vegetables, fruits, flowers, or seeds. Additionally, marketable yield trait may refer to the growth of the plant, the hardiness of the plant (including flowers), and/or the color or taste of the plant.

Methods of assessing the toxicity of a metal compound to the plant are detailed in the examples. For instance, the toxicity of the compound may be assessed by periodically inspecting the plants after application of the compound to the plant during the growth cycle to determine visually the condition of the plant. The condition of the plant may be rated on a visual toxicity scale in which a score of zero corresponds to no visible injury and a score of ten corresponds to plant death. Another method of assessing the toxicity of the compound is to periodically inspect the leaves of the plants and to rate the plants on a visual greenness scale in which a score of one corresponds to healthy green leaves and a score of 5 corresponds to significant necrosis in the leaves of the plant. As used herein, “foliar toxicity” refers to the adverse effect of a compound on a growing plant in which the leaves of the plant display significant yellowing or necrosis over at least 10% of the total leaf area of the plant.

(a) plants

A metal compound of the invention may be used to provide a metal micronutrient to a wide variety of plants. It is envisioned, as shown in the Examples, that the metal compounds will provide a variety of benefits to the plant. Generally speaking, though, the benefit may be increased growth or production of the plant. For example, in vegetable plants, fruit plants, grain plants, or other harvestable plants, the benefit may be an increase in marketable yield, or an improvement in a marketable yield trait, such as better taste or better color. Alternatively, in floral plants such as houseplants, the benefit may be hardier flowers, a greater number of flowers, or better floral color.

A plant, as used herein, is to be interpreted broadly to include both crop and non-crop plants and both edible and non-edible plants. For instance, plants may include the class of higher and lower plants, including angiosperms (i.e., monocotyledonous and dicotyledonous plants), gymnosperms, ferns, horsetails, psilophytes, lycophytes, bryophytes, and multicellular algae. In a typical embodiment, the plant may be any vascular plant, for example monocotyledons or dicotyledons or gymnosperms. In particular, plants may include vegetable plants, herb and spice plants, fruit plants, trees, house plants, and grain plants. Non-limiting examples of plants are detailed below.

i. Vegetables

In one embodiment, the plant is a vegetable plant. Non-limiting examples of vegetables may include leafy and salad vegetables such as Amaranth (Amaranthus cruentus), Bitterleaf (Vernonia calvoana), Bok choy (Brassica rapa Pekinensis and Chinensis groups), Brussels sprout (Brassica oleracea Gemmifera group), Cabbage (Brassica oleracea Capitata group), Catsear (Hypochaeris radicata), Celtuce (Lactuca sativa var. asparagine), Ceylon spinach (Basella alba), Chicory (Cichorium intybus), Chinese Mallow (Malva verticillata), Chrysanthemum (Chrysanthemum coronarium), Corn salad (Valerianella locusta), Cress (Lepidium sativum), Dandelion (Taraxacum officinale), Endive (Cichorium endivia), Epazote (Chenopodium ambrosioides), Fat hen (Chenopodium album), Fiddlehead (Pteridium aquilinum, Athyrium esculentum), Fluted pumpkin (Telfairia occidentalis), Golden samphire (Inula crithmoides), Good King Henry (Chenopodium bonus-henricus), Ice plant (Mesembryanthemum crystallinum), Kai-Ian (Brassica rapa Alboglabra group), Komatsuna (Brassica rapa Pervidis or Komatsuna group), Kuka (Adansonia spp.), Lagos bologi (Talinum fruticosum), Land cress (Barbarea verna), Lettuce (Lactuca sativa), Lizard's tail (Houttuynia cordata), Melokhia (Corchorus olitorius, Corchorus capsularis), Mizuna greens (Brassica rapa Nipposinica group), Mustard (Sinapis alba), New Zealand Spinach (Tetragonia tetragonioides), Orache (Atriplex hortensis), Polk (Phytolacca americana), Radicchio (Cichorium intybus), Garden Rocket (Eruca sativa), Samphire (Crithmum maritimum), Sea beet (Beta vulgaris subsp. maritima), Seakale (Crambe maritima), Sierra Leone bologi (Crassocephalum spp.), Soko (Celosia argentea), Sorrel (Rumex acetosa), Spinach (Spinacia oleracea), Summer purslane (Portulaca oleracea), Swiss chard (Beta vulgaris subsp. cicla var. flavescens), Tatsoi (Brassica rapa Rosularis group), Watercress (Nasturtium officinale), Water spinach (Ipomoea aquatica) and Winter purslane (Claytonia perfoliata); fruiting and flowering vegetables such as Armenian cucumber (Cucumis melo Flexuosus group), Eggplant or Aubergine (Solanum melongena), Avocado (Persea americana), Bell pepper (Capsicum annuum), Bitter melon (Momordica charantia), Caigua (Cyclanthera pedata), Cape Gooseberry (Physalis peruviana), Cayenne pepper (Capsicum frutescens), Chayote (Sechium edule), Chili pepper (Capsicum annuum Longum group), Cucumber (Cucumis sativus), Globe Artichoke (Cynara scolymus), Luffa (Luffa acutangula, Luffa aegyptiaca), Malabar gourd (Cucurbita ficifolia), Marrow (Cucurbita pepo), Parwal (Trichosanthes dioica), Perennial cucumber (Coccinia grandis), Pumpkin (Cucurbita maxima, Cucurbita pepo), Pattypan squash, Snake gourd (Trichosanthes cucumerina), Sweetcorn (Zea mays), Sweet pepper (Capsicum annuum Grossum group), Tinda (Praecitrullus fistulosus), Tomato (Solanum lycopersicum), Tomatillo (Physalis philadelphica), Winter melon (Benincasa hispida), West Indian gherkin (Cucumis anguria) and Zucchini or Courgette (Cucurbita pepo); podded vegetables such as American groundnut (Apios americana), Azuki bean (Vigna angularis), Black-eyed pea (Vigna unguiculata subsp. unguiculata), Chickpea (Cicer arietinum), Drumstick (Moringa oleifera), Dolichos bean (Lablab purpureus), Fava bean (Vicia faba), French bean (Phaseolus vulgaris), Guar (Cyamopsis tetragonoloba), Horse gram (Macrotyloma uniflorum), Indian pea (Lathyrus sativus), Lentil (Lens culinaris), Moth bean (Vigna acontifolia), Mung bean (Vigna radiata), Okra (Abelmoschus esculentus), Pea (Pisum sativum), Peanut (Arachis hypogaea), Pigeon pea (Cajanus cajan), Rice bean (Vigna umbellatta), Runner bean (Phaseolus coccineus), Soybean (Glycine max), Tarwi (tarhui, chocho; Lupinus mutabilis), Tepary bean (Phaseolus acutifolius), Urad bean (Vigna mungo), Velvet bean (Mucuna pruriens), Winged bean (Psophocarpus tetragonolobus) and Yardlong bean (Vigna unguiculata subsp. sesquipedalis); bulb and stem vegetables such as Asparagus (Asparagus officinalis), Cardoon (Cynara cardunculus), Celeriac (Apium graveolens var. rapaceum), Celery (Apium graveolens), Elephant Garlic (Allium ampeloprasum var. ampeloprasum), Florence fennel (Foeniculum vulgare var. dulce), Garlic (Allium sativum), Kohlrabi (Brassica oleracea Gongylodes group), Kurrat (Allium ampeloprasum var. kurrat), Leek (Allium porrum), Nopal (Opuntia ficus-indica), Onion (Allium cepa), Prussian asparagus (Omithogalum pyrenaicum), Shallot (Allium cepa Aggregatum group), Welsh onion (Allium fistulosum) and Wild leek (Allium tricoccum); root and tuberous vegetables such as Acorn squash (Cucurbita pepo), Ahipa (Pachyrhizus ahipa), Arracacha (Arracacia xanthorrhiza), Bamboo shoot, Beetroot (Beta vulgaris subsp. vulgaris), Black cumin (Bunium persicum), Broadleaf arrowhead (Sagittaria latifolia), Canna (Canna spp.), Carrot (Daucus carota), Cassava (Manihot esculenta), Chinese artichoke (Stachys affinis), Daikon (Raphanus sativus Longipinnatus group), Earthnut pea (Lathyrus tuberosus), Elephant Foot yam (Amorphophallus paeoniifolius), Ensete (Ensete ventricosum), Ginger (Zingiber officinale), Gobo (Arctium lappa), Hamburg parsley (Petroselinum crispum var. tuberosum), Jerusalem artichoke (Helianthus tuberosus), Jicama (Pachyrhizus erosus), Parsnip (Pastinaca sativa), Pignut (Conopodium majus), Plectranthus (Plectranthus spp.), Potato (Solanum tuberosum), Prairie turnip (Psoralea esculenta), Radish (Raphanus sativus), Rutabaga (Brassica napus Napobrassica group), Salsify (Tragopogon porrifolius), Scorzonera (Scorzonera hispanica), Skirret (Sium sisarum), Sweet Potato (Kumara), Taro (Colocasia esculenta), Ti (Cordyline fruticosa), Tigernut (Cyperus esculentus), Turnip (Brassica rapa Rapifera group), Ulluco (Ullucus tuberosus), Wasabi (Wasabia japonica), Water chestnut (Eleocharis dulcis), Yacón (Smallanthus sonchifolius), and Yam (Dioscorea spp.).

ii. Herb and Spice Plants

In another embodiment, the plant is an herb and/or a spice plant. Non-limiting examples of herbs and spices may comprise Ajwain (Trachyspermum ammi), Alkanet (Anchusa arvensis), Allspice (Pimenta dioica), Almond, Amchur—mango (Mangifera), Angelica (Angelica archangelica), Anise (Pimpinella anisum), Aniseed myrtle (Syzygium anisatum), Annatto (Bixa orellana L.), Apple mint (Mentha suaveolens), Mugwort (Artemisia vulgaris), Asafoetida (Ferula assafoetida), Berberis, Banana, Basil (Ocimum basilicum), Bay leaves, Black cardamom, Black cumin, Blackcurrant, Black lime, Bladder wrack (Fucus vesiculosus), Blue-leaved mallee (Eucalyptus polybractea), Bog Labrador (Rhododendron groenlandicum), Boldo (Peumus boldus), Bolivian Coriander (Porophyllum ruderale), Borage (Borago officinalis), Calendula, Calumba (Jateorhiza calumba), Cananga, Chamomile, Candle nut, Cannabis, Caper (Capparis spinosa), Caraway, Cardamom, Carob Pod, Cassia, Casuarina, Catnip, Cat's Claw, Catsear, Cayenne pepper, Celastrus Paniculatus, Centaury, Chervil (Anthriscus cerefolium), Chickweed, Chicory, Chile pepper, Chipotle, Chives (Allium schoenoprasum), Cicely (Myrrhis odorata), Cilantro (Coriandrum sativum), Cinchona (Cinchona), Cinnamon (and Cassia), Cinnamon Myrtle (Backhousia myrtifolia), Clary, Cleavers, Clover, Cloves, Coffee, Comfrey, Common Rue, Condurango, Coptis, Coriander, Costmary (Tanacetum balsamita), Couchgrass, Cow Parsley (Anthriscus sylvestris), Cowslip, Cramp Bark (Viburnum opulus), Cress, Cuban Oregano (Plectranthus amboinicus), Cudweed, Cumin, Curry leaf (Murraya koenigii), Damiana (Turnera aphrodisiaca, T. diffusa), Dandelion (Taraxacum officinale), Demulcent, Devil's claw (Harpagophytum procumbens), Dill (Anethum graveolens), Dorrigo Pepper (Tasmannia stipitata) Echinacea, Echinopanax Elatum, Edelweiss, Elderberry, Elderflower, Elecampane, Eleutherococcus senticosus, Emmenagogue, Epazote (Chenopodium ambrosioides), Ephedra, Eryngium foetidum, Eucalyptus, Eyebright, Fennel (Foeniculum vulgare), Fenugreek, Feverfew, Figwort, Fo-ti-tieng, Fumitory, Galangal, Garam masala, Garden cress, Garlic chives, Garlic, Ginger, (Zingiber officinale), Ginkgo biloba, Ginseng, Goat's Rue (Galega officinalis), Goada masala, Gotu Kola, Grains of paradise (Aframomum melegueta), Grains of Selim (Xylopia aethiopica), Green tea, Ground Ivy, Guaco, Gypsywort, Hawthorn (Crataegus sanguinea), Hawthorne Tree, Hibiscus, Holly, Holy Thistle, Hops, Horehound, Horseradish, Horsetail (Equisetum telmateia), Hyssop (Hyssopus officinalis), Imli (Tamarind), Jalap, Jasmine, Jiaogulan (Gynostemma pentaphyllum), Joe Pye weed (Gravelroot), John the Conqueror, Juniper, Kaffir Lime (Citrus hystrix, C. papedia), Kaala masala, Knotweed, Kokam, Labrador tea, Lady's Bedstraw, Lady's Mantle, Land cress, Lavender (Lavandula spp.), Ledum, Lemon Balm (Melissa Officinalis), Lemon basil, Lemongrass (Cymbopogon citratus, C. flexuosus, and other species), Lemon Ironbark (Eucalyptus staigeriana), Lemon mint, Lemon Myrtle (Backhousia citriodora), Lemon Thyme, Lemon verbena (Lippia citriodora), Licorice—adaptogen, Lime Flower, Limnophila aromatica, Lingzhi, Linseed, Liquorice, Long pepper, Lovage (Levisticum officinale), Luohanguo, Mace, Mahlab, Malabathrum, Manchurian Thorn Tree (Aralia manchurica), Mandrake, Marjoram (Origanum majorana), Marrubium vulgare, Marsh Labrador Tea, Marshmallow, Mastic, Meadowsweet, Mei Yen, Melegueta pepper (Aframomum melegueta), Mint (Mentha spp.), Milk thistle (Silybum), Bergamot (Monarda didyma), Motherwort, Mountain Skullcap, Mullein (Verbascum thapsus), Mustard, Nashia inaguensis, Neem, Nepeta, Nettle, Nigella sativa, Nigella (Kolanji, Black caraway), Noni, Nutmeg, Oenothera (Oenothera biennis et al), Olida (Eucalyptus olida), Oregano (Origanum vulgare, O. heracleoticum, and other species), Orris root, Osmorhiza, Olive Leaf, Pandan leaf, Paprika, Parsley (Petroselinum crispum), Passion Flower, Patchouli, Pennyroyal, Pepper (black, white, and green), Peppermint, Peppermint Gum (Eucalyptus dives), Perilla, Plantain, Pomegranate, Ponch phoran, Poppy, Primrose (Primula), Psyllium, Purslane, Quassia, Quatre épices, Ramsons, Ras el-hanout, Raspberry, Reishi, Restharrow, Rhodiola rosea, Riberry (Syzygium luehmannii), Rocket/Arugula, Roman chamomile, Rooibos, Rosehips, Rosemary (Rosmarinus officinalis), Rowan Berries, Rue, Safflower, Saffron, Sage (Salvia officinalis), Saigon Cinnamon, St John's Wort, Salad Burnet (Sanguisorba minor or Poterium sanguisorba), Salvia, Sichuan Pepper (Sansho), Sassafras, Savory (Satureja hortensis, S. Montana), Schisandra (Schisandra chinensis), Scutellaria costaricana, Senna, Senna obtusifolia, Sesame, Sheep Sorrel, Shepherd's Purse, Sialagogue, Siberian Chaga, Siberian ginseng (Eleutherococcus senticosus), Siraitia grosvenorii (luohanguo), Skullcap, Sloe Berries, Smudge Stick, Sonchus, Sorrel (Rumex spp.), Southernwood, Spearmint, Speedwell, Squill, Star anise, Stevia, Strawberry Leaves, Suma (Pfaffia paniculata), Sumac, Summer savory, Sutherlandia frutescens, Sweet grass, Sweet cicely (Myrrhis odorata), Sweet woodruff, Szechuan pepper (Xanthoxylum piperitum), Tacamahac, Tamarind, Tandoori masala, Tansy, Tarragon (Artemisia dracunculus), Tea (Camellia sinensis), Teucrium polium, Thai basil, Thistle, Thyme, Toor DaII, Tormentil, Tribulus terrestris, Tulsi (Ocimum tenuiflorum), Turmeric (Curcuma longa), Twinleaf onion, Uva Ursi also known as Bearberry, Vanilla (Vanilla planifolia), Vasaka, Vervain, Vetiver, Vietnamese Coriander (Persicaria odorata), Wasabi (Wasabia japonica), Watercress, Wattleseed, Wild ginger, Wild Lettuce, Wild thyme, Winter savory, Witch Hazel, Wolfberry, Wood Avens, Wood Betony, Woodruff, Wormwood, Yarrow, Yerba Buena, Yohimbe, Yomogi, and Zedoary Root.

iii. Fruit Plants

In yet another embodiment, the plant is a fruit plant. Non-limiting examples of fruits may include Apple and crabapple (Malus), Chokeberry (Aronia), Hawthorn (Crataegus and Rhaphiolepis), Loquat (Eryobotrya japonica), Medlar (Mespilus germanica), Pear, European and Asian species (Pyrus), Quince (Cydonia oblonga and Chaenomeles), Rose hip, Rowan (Sorbus), Service tree (Sorbus domestica), Serviceberry or Saskatoon (Amelanchier), Shipova (Sorbopyrus auricularis), Apricot (Prunus armeniaca or Armeniaca vulgaris); Sweet, black, sour, and wild cherry species (Prunus avium, Prunus serotina, P. cerasus, and others), Chokecherry (Prunus virginiana), Greengage, a cultivar of the plum, hybrids of the preceding species, such as the pluot, aprium and peacotum, Peach (of the normal and white variety) and its variant the nectarine (Prunus persica), Plum, of which there are several domestic and wild species, Blackberry, of which there are many species and hybrids, such as dewberry, boysenberry, olallieberry, tayberry and loganberry (genus Rubus), Cloudberry (Rubus chamaemorus), Loganberry (Rubus loganobaccus), Raspberry, several species (genus Rubus), Salmonberry (Rubus spectabilis), Thimbleberry (Rubus parviflorus), Wineberry (Rubus phoenicolasius), Bearberry (Arctostaphylos spp.), Bilberry or whortleberry (Vaccinium spp.), Blueberry (Vaccinium spp.), Crowberry (Empetrum spp.), Cranberry (Vaccinium spp.), Huckleberry (Vaccinium spp.), Lingonberry (Vaccinium vitis-idaea), Strawberry Tree (Arbutus unedo), Açai (Euterpe), Barberry (Berberis; Berberidaceae), Currant (Ribes spp.; Grossulariaceae), red, black, and white types, Elderberry (Sambucus; Caprifoliaceae), Gooseberry (Ribes spp.; Grossulariaceae), Hackberry (Celtis spp.; Cannabaceae), Honeysuckle, (Lonicera spp.; Caprifoliaceae), Mulberry (Morus spp.; Moraceae), Mayapple (Podophyllum spp.; Berberidaceae), Nannyberry or sheepberry (Viburnum spp.; Caprifoliaceae), Oregon grape (Mahonia aquifolium; Berberidaceae), Sea-buckthorn (Hippophae rhamnoides; Elaeagnaceae), Sea Grape (Coccoloba uvifera; Polygonaceae), Wolfberry (Lycium barbarum, Lycium spp.; Solanaceae), Arhat (Siraitia grosvenorii; Cucurbitaceae), Che (Cudrania tricuspidata; Moraceae), Chinese Mulberry, Cudrang, Mandarin Melon Berry, Silkworm Thorn, Zhe, Goumi (Elaeagnus multiflora ovata; Elaeagnaceae), Hardy Kiwi (Actinidia arguta), Kiwifruit or Chinese gooseberry (Actinidia spp.; Actinidiaceae), Lapsi (Choerospondias axillaris Roxb.), Nungu, Persimmon (aka Sharon Fruit, Diospyros kaki; Ebenaceae), Rhubarb (Rheum rhaponticum; Polygonaceae), Sageretia (Sageretia theezans; Rhamnaceae) also called Mock Buckthorn, American grape: North American species (e.g., Vitis labrusca; Vitaceae) and American-European hybrids, grape (Vitis vinifera), American Mayapple (Podophyllum peltatum; Berberidaceae), American persimmon (Diospyros virginiana; Ebenaceae), Beach Plum (Prunus maritima), Blueberry (Vaccinium, sect. Cyanococcus; Ericaceae), Buffaloberry (Shepherdia argenta; Elaeagnaceae), Chokecherry (Prunus virginiana), Cocoplum (Chrysobalanus icaco; Chrysobalanaceae), Cranberry (Vaccinium oxycoccus), False-mastic (Mastichodendron foetidissimum; Sapotaceae), Ground Plum (Astragalus caryocarpus; Fabaceae), also called Ground-plum milk-vetch, Pawpaw (Asimina triloba; Annonaceae), Persimmon (Diospyros virginiana; Ebenaceae), Pigeon plum (Coccoloba diversifolia; Polygonaceae), Salal berry (Gaultheria shallon; Ericaceae), Salmonberry (Rubus spectabilis; Rosaceae), Saw Palmetto (Serenoa repens; Ericaceae), Texas persimmon (Diospyros texana; Ebenaceae), Thimbleberry (Rubus parviflorus; Rosaceae), Toyon (Heteromeles arbutifolia; Rosaceae), Cardón (Pachycereus pringlei; Cactaceae), Dragonfruit (Hylocereus undatus; Cactaceae), also called pitaya, Prickly pear (Opuntia spp.; Cactaceae), Saguaro (Carnegiea gigantea; Cactaceae), Kahikatea (Dacrycarpus dacrydioides), Manoao (Manoao colensoi), Nageia (Nageia spp.), Podocarpus (Podocarpus spp.), Prumnopitys (Prumnopitys spp.), Rimu (Dacrydium cupressinum), Butternut squash (Cucurbita moschata), Cushaw squash (Cucurbita mixta), Hubbard squash, Buttercup squash (Cucurbita maxima), Pumpkin, Acorn squash, Zucchini, Summer squash (Cucurbita pepovarieties), Horned melon (Cucumis metuliferus), Melon (Cucumis melo): cantaloupe, galia, and other muskmelons, honeydew, Raisin tree (Hovenia dulcis, Rhamnaceae) also called Japanese Raisin Tree, Strawberry (Fragaria spp.; Rosaceae), Black mulberry (Morus nigra; Moraceae), Cornelian cherry (Cornus mas; Cornaceae), Date palm (Phoenix dactylifera; Arecaceae), Fig (Ficus spp. Moraceae), Jujube (Ziziphus zizyphus; Rhamnaceae), Olive (Olea europea; Oleaceae), Pomegranate (Punica granatum; Punicaceae), Sycamore fig (Ficus sycomorus; Moraceae), Citron (Citrus medica), Clementine (Citrus reticulata var. Clementine), Grapefruit (Citrus paradisi), hybrids of the preceding species, such as the Orangelo, Tangelo, Rangpur and Ugli fruit, Kumquat (Fortunella), Lemon (Citrus limon), Lime, Key Lime (Citrus aurantifolia), Persian lime, also known as tahiti lime, Kaffir lime (Citrus hystix), Mandarin (Citrus reticulata), Orange, of which there are sweet (Citrus sinensis) and sour (Citrus aurantium) species, Pomelo (also known as the shaddock) (Citrus maxima), Sweet Lemon (Citrus limetta), Tangerine, Avocado (Persea americana; Lauraceae), Carob (Ceratonia siliqua; Fabaceae), Feijoa (Feijoa sellowiana; Myrtaceae), Guava (Psidium guajava; Myrtaceae), Kumquat (Fortunella spp.; Rutaceae), Longan (Euphoria longan; Sapindaceae), Lúcuma (Pouteria lucuma; Sapotaceae), Lychee (Litchi chinensis; Sapindaceae), Passion fruit or Grenadilla (Passiflora edulis and other Passiflora spp.; Passifloraceae), Peanut (Arachis hypogaea; Fabaceae), Pond-apple (Annona glabra; Annonaceae) also called Alligator-apple and Monkey-apple, Strawberry guava (Psidium litorale; Myrtaceae), Tamarillo or Tree Tomato (Cyphomandra betacea; Solanaceae), Ugni (Ugni molinae; Myrtaceae), Yangmei (Myrica rubra; Myricaceae), also called Yamamomo, Chinese Bayberry, Japanese Bayberry, Red Bayberry, or Chinese strawberry tree, Papayas Acerola (Malpighia glabra; Malpighiaceae), also called West Indian Cherry or Barbados Cherry, Ackee (Blighia sapida or Cupania sapida; Sapindaceae), African cherry orange (Citropsis schweinfurthii; Rutaceae), Amazon Grape (Pourouma cecropiaefolia; Moraceae), Araza, Avocado, Açai (Euterpe oleracea; Arecaceae), or assai, Babaco (Carica pentagona; Caricaceae), Bael (Aegle marmelos; Rutaceae), Banana (Musacea spp.; Musaceae); Plantain, Barbadine (granadilla; maracujá-açu in Portuguese), Barbados Cherry (Malpighia glabra L.; Malpighiaceae), also called Acerola, West Indian Cherry, Betel Nut, Bilimbi (Averrhoa bilimbi; Oxalidaceae) also called cucumber tree or tree sorrel, Biriba, Bitter gourd, Black sapote, Bottle gourd, Brazil nut, Breadfruit (Artocarpus altilis; Moraceae), Burmese grape (Baccaurea sapida; Cucurbitaceae), Calabash (Lagenaria siceraria; Bignoniaceae), Calabashtree, CamuCamu (Myrciaria dubia; Myrtaceae), Canistel, Cape gooseberry, Carambola (Averrhoa carambola; Oxalidaceae), also called star fruit or five fingers, Cashew, Cempedak or Champedak (Artocarpus champeden; Moraceae), Ceylon gooseberry, Chenet (guinep or ackee; pitomba-das-Guinas in Portuguese), Cherimoya (Annona cherimola; Annonaceae), Chili pepper, Caimito (caimite; related to the yellow abiu—egg fruit), Cacao, Coconut (Cocos spp.; Arecaceae), Coffee, Cupuagu, Custard apple (Annona reticulata; Annonaceae), also called Bullock's Heart, Damson plum (Chrysophyllum oliviforme; Sapotaceae), also called Satin Leaf, Date, Date-plum (Diospyros lotus; Ebenaceae), Dragonfruit (Hylocereus spp.; Cactaceae), also called pitaya, Durian (Durio spp.; Bombacaceae), Eggfruit (Pouteria campechiana; Sapotaceae), also called canistel or yellow sapote, Elephant apple (Dillenia indica; Dilleniaceae), Giant granadilla, Guarana (Paullinia cupana; Sapindaceae), Guava, Guavaberry or Rumberry; (Myrciaria floribunda; Myrtaceae), Hog plum (taperebá in Portuguese), Huito (Genipa americana; Rubiaceae); also called jagua, genipap, jenipapo, Indian almond, Indian fig, Indian jujube, Indian Prune (Flacourtia rukan; Flacourtiaceae), Jaboticaba (Myrciaria cauliflora; Myrtaceae), also called Brazilian Grape Tree, Jackfruit (Artocarpus heterophyllus Moraceae), also called nangka, Jambul (Syzygium cumini; Myrtaceae), Jatobá (Hymenae coubaril; Leguminosae; Caesalpinioideae), Jocote, also called Jamaica Plum, Kandis (Garcinia forbesii; Clusiaceae), Keppel fruit (Stelechocarpus burakol; Annonaceae), Kumquat, Kundong (Garcinia sp.; Clusiaceae), Lablab, Langsat (Lansium domesticum), also called longkong or duku, Lansones (Lansium domesticum spp.; Meliaceae), Leucaena, Longan, Loquat, Lucuma, Mabolo (Diospyros discolor; Ebenaceae) also known as a velvet persimmon, Macadamia, Mamey sapote (Pouteria sapota; Sapotaceae); also known as mamee apple; abricó in Portuguese Mamoncillo (Melicoccus bijugatus; Sapindaceae), also known as quenepa, genip or Fijian Longan, Manila tamarind (or Monkeypod, Pithecellobium dulce), Mango (Mangifera indica; Anacardiaceae), Mangosteen (Garcinia mangostana; Clusiaceae), Marang (Artocarpus odoratissima; Moraceae), a breadfruit relative, Melinjo, Melon pear, Monstera (Monstera deliciosa; Araceae) also called Swiss Cheese Plant, Split-leaf Philodendron, Morinda, Mountain soursop, Mundu, Mung bean, Muskmelon, Nance, Naranjilla, Lulo (Solanum quitoense; Solanaceae), Nutmeg, Neem, Oil Palm, Okra, Papaya (Carica papaya; Caricaceae), Peach palm, Peanut butter fruit (Bunchosia argentea; Malpighiaceae), Pequi or Souari Nut (Caryocar brasiliense; Caryocaraceae), Pewa (peach palm; pupunha in Portuguese), Pigeon pea, Pili nut, Pineapple (Ananas comosus or Ananas sativas; Bromeliaceae), Pitomba (Eugenia luschnathiana or Talisia esculenta), Poha or Cape Gooseberry (Physalis peruviana; Solanaceae), Pois doux (Inga edulis, ice-cream bean, or inga-cipó in Portuguese), Poisonleaf (Dichapetalum cymosum), Pommecythére or pomcité (Spondias cytherea); also known as golden apple, June plum or Jew plum and ambarella, and as cajamanga in Portuguese, Pommerac (Eugenia malaccensis); also known as Otaheite apple; Malay apple; jambo in Portuguese, Pulasan, Pummelo, Pupunha or peach-palm (Bactris gasipaes; Palmae); also known as pewa, Queensland nut, Rambutan (Nephelium lappaceum; Sapindaceae), Red Mombin (Spondias purpurea; Anacardiaceae), Riberry (Syzygium luehmannii; Myrtaceae), also called Lilly Pilly, Lillipilli, Chinese Apple, Ridged gourd, Salak (Salacca edulis), also called snakefruit, Santol (Sandoricum koetjape; Meliaceae), Sapodilla (Achras/Manilkara zapota; Sapotaceae), also called chiku, mespel, naseberry, sapadilla, snake fruit, sawo, Sea grape, Soncoya, Soursop (Annona muricata; Annonaceae), also called guanabana, Soybean, Star apple (Chrysophyllum cainito), also called caimito or caimite, Strawberry guava, Strawberry pear, Sugar apple (Annona squamosa; Annonaceae); Ata, Summer squash, Surinam Cherry (Eugenia uniflora; Myrtaceae) also called Brazilian Cherry, Cayenne Cherry, Pitanga, Sweet granadilla, Sweet orange, Sweet pepper, Sweetsop, Rose apple (Syzygium jambos; Myrtaceae), also called Malay apple, Tamarind (Tamarindus indica; Caesalpiniaceae), Vanilla, Water apple, Watermelon, Wax apple (Syzygium samarangense), Wax gourd, White sapote, and Winged bean.

iv. Trees

In still another embodiment, the plant may be a tree. In some embodiments, the plant may be a Dicotyledon (Magnoliopsida; broadleaf or hardwood trees). Non-limiting examples may include the Adoxaceae (Moschatel family), such as Moschatel (Adoxa moschatellina), Elderberry (Sambucus species), Sinadoxa (Sinadoxa corydalifolia), and Viburnum (Viburnum species); the Altingiaceae (Sweetgum family) such as Sweetgum (Liquidambar species); the Anacardiaceae (Cashew family) such as Cashew (Anacardium occidentale), Mango (Mangifera indica), Pistachio (Pistacia vera), Sumac (Rhus species), and Lacquer tree (Toxicodendron verniciflua); the Annonaceae (Custard apple family) such as Cherimoya (Annona cherimola), Custard apple (Annona reticulate), Pawpaw (Asimina triloba), and Soursop (Annona muricata); the Apocynaceae (Dogbane family) such as Pachypodium (Pachypodium species); the Aquifoliaceae (Holly family) such as Holly (Ilex species); the Araliaceae (Ivy family) such as Kalopanax (Kalopanax pictus); the Betulaceae (Birch family) such as Alder (Alnus species), Birch (Betula species), Hornbeam (Carpinus species), and Hazel (Corylus species); the Bignoniaceae such as Catalpa (Catalpa species); the Cactaceae (Cactus family) such as Saguaro (Carnegiea gigantean); the Cannabaceae (Cannabis family) such as Hackberry (Celtis species); the Cornaceae (Dogwood family) such as Dogwood (Cornus species); the Dipterocarpaceae family such as Garjan (Dipterocarpus species) and Sal (Shorea species); the Ebenaceae (Persimmon family) such as Persimmon (Diospyros species); the Ericaceae (Heath family) such as Arbutus (Arbutus species); the Eucommiaceae (Eucommia family) such as Eucommia (Eucommia ulmoides); the Fabaceae (Pea family) such as Acacia (Acacia species), Honey locust (Gleditsia triacanthos), Black locust (Robinia pseudoacacia), Laburnum (Laburnum species), and Pau Brasil, Brazilwood, (Caesalpinia echinata); the Fagaceae (Beech family) such as Chestnut (Castanea species), Beech (Fagus species), Southern beech (Nothofagus species), Tanoak (Lithocarpus densiflorus), and Oak (Quercus species); the Fouquieriaceae (Boojum family) such as Boojum (Fouquieria columnaris); the Hamamelidaceae (Witch-hazel family) such as Persian Ironwood (Parrotia persica); the Juglandaceae (Walnut family) such as Walnut (Juglans species), Hickory (Carya species), and Wingnut (Pterocarya species); the Lauraceae (Laurel family) such as Cinnamon (Cinnamomum zeylanicum), Bay Laurel (Laurus nobilis), and Avocado (Persea Americana); the Lecythidaceae (Paradise nut family) such as Brazil Nut (Bertholletia excelsa); the Lythraceae Loosestrife family such as Crape-myrtle (Lagerstroemia species); the Magnoliaceae (Magnolia family) such as Tulip tree (Liriodendron species) and Magnolia (Magnolia species); the Malvaceae (Mallow family; including Tiliaceae, Sterculiaceae and Bombacaceae) such as Baobab (Adansonia species), Silk-cotton tree (Bombax species), Bottletrees (Brachychiton species), Kapok (Ceiba pentandra), Durian (Durio zibethinus), Balsa (Ochroma lagopus), Cacao (cocoa) (Theobroma cacao), and Linden (Basswood, Lime) (Tilia species); the Meliaceae (Mahogany family) such as Neem (Azadirachta indica), Bead tree (Melia azedarach), and Mahogany (Swietenia mahagoni); the Moraceae (Mulberry family) such as Fig (Ficus species) and Mulberry (Morus species); the Myristicaceae (Nutmeg family) such as Nutmeg (Mysristica fragrans); the Myrtaceae (Myrtle family) such as Eucalyptus (Eucalyptus species), Myrtle (Myrtus species) and Guava (Psidium guajava); the Nyssaceae (Tupelo family; sometimes included in Cornaceae) such as Tupelo (Nyssa species) and Dove tree (Davidia involucrate); the Oleaceae (Olive family) such as Olive (Olea europaea) and Ash (Fraxinus species); the Paulowniaceae (Paulownia family) such as Foxglove Tree (Paulownia species); the Platanaceae (Plane family) such as Plane (Platanus species); the Rhizophoraceae (Mangrove family) such as Red Mangrove (Rhizophora mangle); the Rosaceae (Rose family) such as Rowans, Whitebeams, Service Trees (Sorbus species), Hawthorn (Crataegus species), Pear (Pyrus species), Apple (Malus species), Almond (Prunus dulcis), Peach (Prunus persica), Apricot (Prunus armeniaca), Plum (Prunus domestica) and Cherry (Prunus species); the Rubiaceae (Bedstraw family) such as Coffee (Coffea species); the Rutaceae (Rue family) such as Citrus (Citrus species), Cork-tree (Phellodendron species) and Euodia (Tetradium species); the Salicaceae (Willow family) such as Aspen (Populus species), Poplar (Populus species) and Willow (Salix species); the Sapindaceae (including Aceraceae, Hippocastanaceae) (Soapberry family) such as Maple (Acer species), Buckeye, Horse-chestnut (Aesculus species), Mexican Buckeye (Ungnadia speciosa), Lychee (Litchi sinensis) and Golden rain tree (Koelreuteria); the Sapotaceae (Sapodilla family) such as Argan (Argania spinosa), Gutta-percha (Palaquium species) and Tambalacoque, or “dodo tree” (Sideroxylon grandiflorum, previously Calvaria major); the Simaroubaceae family such as Tree of heaven (Ailanthus species); the Theaceae (Camellia family) such as Gordonia (Gordonia species) and Stewartia (Stewartia species); the Thymelaeaceae (Thymelaea family) such as Ramin (Gonystylus species); the Ulmaceae (Elm family) such as Elm (Ulmus species) and Zelkova (Zelkova species); and the Verbenaceae family such as Teak (Tectona species).

In other embodiments, the tree may be a Monocotyledon (Liliopsida). Non-limiting examples may include the Agavaceae (Agave family) such as Cabbage tree (Cordyline australis), Dragon tree (Dracaena draco), and Joshua tree (Yucca brevifolia); the Arecaceae (Palmae) (Palm family) such as Areca Nut (Areca catechu), Coconut (Cocos nucifera), Date Palm (Phoenix dactylifera) and Chusan Palm (Trachycarpus fortune); and the Poaceae (grass family) such as Bamboos (Poaceae subfamily Bambusoideae)

In still other embodiments, the tree may be a Conifer (Pinophyta; softwood trees). Non-limiting examples may include the Araucariaceae (Araucaria family) such as Araucaria (Araucaria species), Kauri (Agathis species) and Wollemia (Wollemia nobilis); the Cupressaceae (Cypress family) such as Cypress (Cupressus and Chamaecyparis species), Juniper (Juniperus species), Alerce or Patagonian cypress (Fitzroya cupressoides), Sugi (Cryptomeria japonica), Coast Redwood (Sequoia sempervirens), Giant Sequoia (Sequoiadendron giganteum), Dawn Redwood (Metasequoia glyptostroboides), Western Redcedar (Thuja plicata) and Bald Cypress (Taxodium species); the Pinaceae (Pine family) such as White pine (Pinus species), Pinyon pine (Pinus species), Pine (Pinus species), Spruce (Picea species), Larch (Larix species), Douglas-fir (Pseudotsuga species), Fir (Abies species) and Cedar (Cedrus species); the Podocarpaceae (Yellowwood family) such as African Yellowwood (Afrocarpus falcatus), Totara (Podocarpus totara), Miro (Prumnopitys ferruginea), Kahikatea (Dacrycarpus dacrydioides) and Rimu (Dacrydium cupressinum); Sciadopityaceae such as Kusamaki (Sciadopitys species); and the Taxaceae (Yew family) such as Yew (Taxus species).

In certain embodiments, the tree may be a Ginkgos (Ginkgophyta) of the Ginkgoaceae (Ginkgo family) such as Ginkgo biloba. In some embodiments, the tree may be a Cycads (Cycadophyta). Non-limiting examples may include Cycadaceae (Cycad family) such as Ngathu cycad (Cycas angulata). In some other embodiments, the tree may be from the Zamiaceae (Zamia family) such as Wunu cycad (Lepidozamia hopei). In still some other embodiments, the tree may be a Fern (Pteridophyta), such as a Cyatheaceae or a Dicksoniaceae, including the tree ferns, Cyathea, Alsophila, and Dicksonia.

v. Houseplants

In a further embodiment, the plant may be a houseplant. Non-limiting examples may include tropical and subtropical houseplants such as Aglaonema (Chinese Evergreen), Aphelandra squarrosa (Zebra Plant), Araucaria heterophylla (Norfolk Island Pine), Asparagus densiflorus (Asparagus Fern), Begonia species and cultivars, Bromeliaceae (Bromeliads), Chamaedorea elegans (Parlor Palm), Chlorophytum comosum (Spider Plant), Citrus, compact cultivars such as the Meyer Lemon, Dracaena, Dieffenbachia (Dumbcane), Epipremnum aureum (Golden Pothos), Ficus benjamina (Weeping Fig), Ficus elastica (Rubber Plant), Mimosa pudica (Sensitive Plant), Nephrolepis exaltata cv. Bostoniensis (Boston Fern), Orchidaceae (the orchids), Peperomia species, Philodendron species, Maranta (The Prayer Plants), Saintpaulia (African violet), Sansevieria trifasciata (Mother-inlaw's tongue), Schefflera arboricola (Umbrella Plant), Sinningia speciosa (Gloxinia), Spathiphyllum (Peace Lily), and Tradescantia zebrina (Purple Wandering Jew); succulents such as Aloe barbadensis (Syn. Aloe vera), Cactaceae (Cacti), and Crassula ovata (Jade Plant); forced bulbs such as Crocus, Hyacinthus (Hyacinth), and Narcissus (Narcissus or Daffodil); and temperate houseplants such as Hedera helix (English Ivy) and Saxifraga stolonifera (Strawberry Begonia).

vi. Grains

In still a further embodiment, the plant may be a grain plant (i.e., a cereal). Non-limiting examples may include barley, buckwheat, corn or maize, millet, oats, quinoa, rice, wild rice, rye, spelt, and wheat.

### (b) Administration

The metal compound of the invention may be administered to a plant by any effective means. In some embodiments, the metal compound is combined with a liquid and sprayed and/or dripped onto the plant (i.e. foliar application or fertigation). In other embodiments, the metal compound may be applied directly to the soil. In still other embodiments, the metal compound may be administered to a plant in a composition as described in section I above. If the metal compound is administered as part of a composition, then the metal compound may be administered simultaneously or sequentially with the other components of the composition. Generally speaking, the components should be administered within about 2 weeks, 1 week, 3 days, 2 days, 36 hours, 24 hours, 20 hours, 16 hours, 12 hours, 8 hours, 4 hours, or 1 hour of each other.

It is also envisioned that a metal compound of the invention, or a composition as detailed in section I above, may be applied to a plant or its progeny at various stages of its development. In this context, the term “plant” includes whole plants and parts thereof, including, but not limited to, shoot vegetative organs/structures (e.g., leaves, stems and tubers), roots, flowers and floral organs/structures (e.g., bracts, sepals, petals, stamens, carpels, anthers and ovules), seed (including embryo, endosperm, and seed coat) and fruit (the mature ovary), plant tissue (e.g., vascular tissue or ground tissue) and cells (e.g., guard cells or egg cells), and progeny of the plant or any of the aforementioned parts of the plant. In an exemplary embodiment, the application occurs during the stages of germination, seedling growth, vegetative growth, and reproductive growth. More typically, applications of the present invention occur during vegetative and reproductive growth stages.

It is envisioned that the method may involve more than one application of the composition to the plant or its progeny. For example, the number of applications may range from about 1 to about 5 or more. The applications, as detailed herein, may be made at the same or different stages of the plant's life cycle.

### III. Methods for Reducing Insect Damage

Yet another aspect of the invention encompasses a method for reducing insect damage to a plant. Generally speaking, the method comprises administering to the plant an effective amount of at least one metal compound, as detailed in section I(a) above. In an exemplary embodiment, the method comprises administering an effective amount of at least one metal chelate, wherein the chelate comprises a compound of formula (I):

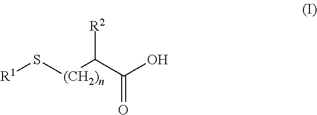

wherein:

n is an integer from 0 to 2;

R¹ is methyl or ethyl; and

R² is hydroxyl or amino.

In some embodiments of the method, when R¹ of formula (I) is methyl, R² is not an amino. In another exemplary embodiment of the method, n of formula (I) is 2, R¹ is methyl and R² is hydroxyl. Stated another way, the metal chelate is comprised of HMTBA.

In other embodiments, the method comprises administering to the plant an effective amount of a composition, as detailed in section I above.

Typically, an “effective amount” of a metal compound, as used herein, can and will vary depending in part on the metal compound, the plant, and the insect. Generally speaking, however, no reduction in insect damage to the plant will occur below the effective amount.

A method of the invention may comprise administering at least two, at least three, or at least four metal compounds to a plant. In some embodiments, a method of the invention may comprise administering a combination of metal compounds detailed in Table A above.

Methods of measuring the effectiveness of a metal compound in reducing insect damage to a plant are known in the art. For instance, the plant administered the metal compound, and a similar plant that has not be administered the compound, may be visually scored for insect damage.

In one embodiment, a composition of the invention may be used to reduce insect damage to agricultural crops. These insects may include, for example, coleopterans (beetles), lepidopterans (caterpillars), and mites. The Coleopterans include numerous beetle species including ground beetles, reticulated beetles, skin and larder beetles, long-horned beetles, leaf beetles, weevils, bark beetles, ladybird beetles, soldier beetles, stag beetles, water scavenger beetles, and a host of other beetles.

Particularly important among the Coleoptera are the agricultural pests included within the infraorders Chrysomeliformia and Cucujiformia. Members of the infraorder Chrysomeliformia, including the leaf beetles (Chrysomelidae) and the weevils (Curculionidae), are particularly problematic to agriculture, and are responsible for a variety of insect damage to crops and plants. The infraorder Cucujiformia includes the families Coccinellidae, Cucujidae, Lagridae, Meloidae, Rhipiphoridae, and Tenebrionidae. Within this infraorder, members of the family Chrysomelidae (which includes the genera Exema, Chrysomela, Oreina, Chrysolina, Leptinotarsa, Gonioctena, Oulema, Monozia, Ophraella, Cerotoma, Diabrotica, and Lachnaia), are well-known for their potential to destroy agricultural crops.

In some embodiments, the method may be used to reduce insect damage to a plant detailed in section II above. For instance, a method of the invention may be used to reduce insect damage to vegetable plants, herb and spice plants, fruit plants, trees, house plants, and grain plants.

Non-limiting examples of insect damage that may be reduced by a composition of the invention may include damage from the following non-limiting examples of ornamental plant insects, such as Aphids (including, for instance, the Maple Leaf Aphid or Woolly Alder Aphid), Bagworm, Black Woolly Bear, Boxelder Bug, Boxwood Leaf Miner, Comstock Mealybug, Cottony Cushion Scale, Euonymus Scale, Japanese Beetle, Lacebug, Lubber Grasshopper, Mealybugs, Peony Scale, Plant Hopper—Ormenis septentrionalis (Spinola), Spider Mites, Tea Scale, Wax Scale, Whitefly, White Fringed Beetle, and Zebra Caterpillar; insects that damage corn plants, such as Billbug, Corn Earworm, Corn Rootworm, Cutworms, European Corn Borer, Fall Armyworm, Southern Cornstalk Borer, Sugarcane Beetle, and Wireworm; insects that damage cotton plants such as Boll Weevil, Bollworm, Cotton Aphid, Loopers, Thrips, and the Two-Spotted Spider Mite; insects that damage forage crops such as Alfalfa Weevil, Corn Earworm, Fall Armyworm, Grasshopper, Green June Beetle, Sorghum Webworm, Spittlebug, Two Lined Spittlebug, and White Grub; insects that damage peanut plants such as Burrower Bug, Lesser Cornstalk Borer, Potato Leafhopper, and Spider Mites; insects that damage tobacco plants such as Aphids, Budworm, Cutworm, Flea Beetle, Hornworm, Looper, Snowy Tree Cricket, Tobacco Wireworm, and Vegetable Weevil; insects that damage soybean plants such as Bahia Grass Borer, Brown Stinkbug, Corn Earworm, Caterpillar, Green Cloverworm, Looper, Margined Blister Beetle, Mexican Bean Beetle, Southern Green Stinkbug, Striped Blister Beetle, Three-Cornered Alfalfa Hopper, Velvetbean Caterpillar, and Yellow Striped Armyworm; insects that damage wheat plants such as Cereal Aphids, Cereal Leaf Beetle, European Corn Borer, Grasshopper Damage, True Armyworm; insects that damage fruit plants such as Plant Bug, Codling Moth, Grape Leaf Beetle, Grape Root Borer, Green June Beetle, Japanese Beetle, Oriental Fruit Moth, Peach Tree Borer, Plum Curculio, Plum Curculio, Red-Humped Caterpillar, Rose Chafer, and Shot-Hole Borer Damage; insects that damage vegetable plants, such as Aphids or Plant Lice, Asparagus Beetle, Banded Cucumber Beetle, Black Cutworm, Colorado Potato Beetle, Cowpea Curculio, Cross Striped Cabbage Worm, Diamond Back Moth Larva, Grubs, Harlequin Bug, Hornworm, Imported Cabbage Worm, Leaf-Footed Bug, Lima Bean Vine Borer, Looper, Maggots, Mexican Bean Beetle, Pickleworm, Silver-Spotted Skipper, Spider Mites, Squash Beetle, Striped Cucumber Beetle, Sweet Potato Weevil, Tomato Fruitworm, Tortoise Beetle (Gold Bug), and Vegetable Leaf Miner.

Insect damage may be to the leaves, flowers, stem, or roots of a plant. As used herein, “reducing” the damage from an insect, means that the damage to a plant administered a composition of the invention is less than to a similar plant not administered a composition of the invention. Methods of administering a composition of the invention to a plant are detailed in section II above. Briefly, a composition may be applied by any means known in the art that produces the desired results. For instance, a composition of the invention may be applied foliarly or to the soil in liquid or powder formulations.

The following examples are included to demonstrate preferred embodiments of the invention. It should be appreciated by those of skill in the art that the techniques disclosed in the examples that follow represent techniques discovered by the inventors to function well in the practice of the invention. Those of skill in the art should, however, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense.

### EXAMPLES

The following examples illustrate various iterations of the invention.

### Materials and Methods for Examples 1-3

The following experiments were performed in a green house during the fall of 2007 at GCREC, Balm, University of Florida. Fifteen products, at 3 different application rates were examined. The plot size was 2-gallon pots. Crop set-up, procedures and variables were as follows.

Transplants of ‘Florida-47’ tomato and ‘Aristotle’ bell pepper plants in the 4-true leaf stage (about 6 inches tall) were planted in 2-gal pots on Aug. 27, 2007. Pots were filled with a commercially available planting medium. This medium was selected based on the mineral composition of the products to be applied without providing significant nutritional inputs to the crops. Irrigation was provided with drip lines delivering between 0.50 and 0.33 gal/day/pot for tomato and bell pepper, respectively, and the crops were irrigated three times per day. No foliar pesticides were necessary.

Fertilization with the non-target micronutrients was achieved with custom-made formulas and applied once per week in the potting soil according to current production practices and recommendations and crop requirements. There were four control treatments corresponding to each target micronutrient in which non-Fe, non-Mn, non-Zn or non-Cu pots received all other essential nutrients under non-limiting conditions.

Treatments were applied at three rates (high, medium and low) obtained from the estimated concentration of Zn, Fe, Cu, and Mn foliarly-applied in tomato and bell pepper in field situations (Table 1). Products were weighed and dissolved in 200 ml of deionized water with a non-ionic surfactant and applied to the newly-matured open leaves of each crop at 3 and 7 weeks after transplant (WAT). Treated pots were isolated during application to avoid cross-contamination of other treatments.

Medium nutrient concentration was determined 1 week before treatment. The mineral composition of the medium was 26.8 ppm NH₄—N, 49 ppm NO₃—N, 15.8 ppm P, 91.2 ppm K, 82.3 ppm Ca, 58.2 ppm Mg, 23.9 ppm Na, 125.6 ppm S, 1.33 ppm Fe, 0.39 ppm Mn, 0.35 ppm Zn, 0.05 pp, Cu, 0.04 ppm B, 0 ppm Mo, 0.73 ppm Al, and 12.1 ppm Si. The pH of the medium was 5.36 and the electric conductivity was 1.38 mS/cm. The foliar tissue analysis was performed at 6 WAT and the concentration of N, P, K, Mg, Ca, S, B, Zn, Mn, Fe, and Cu was determined by a commercial laboratory. Plant toxicity was determined at 4 WAT by using a 0-10 visual scale, where 0=no visible damage and 10=total plant death. Marketable fruit weight was collected 2 times in bell pepper and 4 times in tomato following USDA standards.

Data were analyzed using a general linear model, and means were separated using orthogonal contrasts at the 5% significance level.

Abbreviations, as used in all Tables below are as follows: BIOX-A is HMTBA, BIOX-Z is Zn-HMTBA, BIOX-Cu is Cu-HMTBA, BIOX-M is Mn-HMTBA, BIOX-Fe is Fe-HMTBA, BIOX-MEZ is Ca-HMTBA, BIOX-INC is copper sulfate, BIOX-INI is ferrous sulfate, BIOX-INZ is zinc sulfate, BIOX-INM is manganese sulfate, BIOX-GZ is zinc glycinate, BIOX-GC is copper glycinate, BIOX-GF is iron glycinate, BIOX-GM is manganese glycinate, BIOX-EDC is EDTA chelated copper, BIOX-EDZ is EDTA chelated zinc, BIOX-EDI is EDTA chelated iron, BIOX-EDM is EDTA chelated manganese, BIOX-EDDI is EDDHA chelated iron and BIOX-CM is manganese citrate.

TABLE 1
Treatments applied to tomato and bell pepper, Fall 2007, Balm, Florida

| | Tomato | | | Bell Pepper | | |
|---|---|---|---|---|---|---|
| | Low | Med | High | Low | Med | High |
| | Rate | Rate | Rate | Rate | Rate | Rate |
| Products | mg/plant/season | | | mg/plant/season | | |
| BIOX-Z | 65.0 | 130.0 | 195.6 | 16.3 | 32.5 | 48.8 |
| BIOX-Cu | 347.3 | 694.7 | 1389.3 | 86.7 | 174.0 | 347.3 |
| BIOX-M | 1603.1 | 2405.4 | 3206.9 | 400.8 | 601.5 | 801.5 |
| BIOX-MEZ | 52.0 | 104.0 | 156.5 | 13.0 | 26.0 | 39.0 |
| BIOX-INI | 173.7 | 260.7 | 347.3 | 43.3 | 65 | 87 |
| BIOX-GC | 248.1 | 496.2 | 992.4 | 61.9 | 124.3 | 248.1 |
| BIOX-GM | 947.3 | 1421.4 | 1895 | 236.8 | 355.5 | 473.6 |
| BIOX-EDC | 347.3 | 694.7 | 1389.3 | 86.7 | 174 | 347.3 |
| BIOX-EDI | 397.7 | 596.9 | 795.4 | 99.2 | 148.9 | 199.2 |
| CONTROL | — | — | — | — | — | — |
| TREATMENTS (4) | | | | | | |

### Example 1

### Foliar Toxicity

There was significant (P<0.05) foliar injury caused by some of the treatments on tomato and bell pepper plants. The products BIOX-INI, BIOX-GC, BIOX-GM, BIOX-EDC, and BIOX-EDI caused from light leaf speckling to severe necrosis and plant decay (Table 2). Therefore, these materials were excluded from yield analysis. However, their tissue composition is reported in Tables 3 and 4. The remaining products did not show symptoms of foliar toxicity or plant stunting.

BIOX-Cu was applied to the plants at a copper concentration of 0.004% to 0.061% by weight and displayed no foliar injury. However, when applied at comparable ranges of copper concentrations, both BIOX-GC and BIOX-EDC resulted in foliar toxicity, with toxicity scale scores of 7 and 8 respectively.

Similarly, BIOX-M was applied to the plants at a manganese concentration of 0.015% to 0.124% by weight, with no toxic effect on the plant. However, BIOX-GM applied at similar manganese concentrations proved to be toxic to the plants, causing a toxicity scale score of 7.

Both of the iron compositions (BIOX-INI and BIOX-EDI) were toxic to the plants when applied at an iron concentration of 0.002% to 0.026%, with toxicity scale scores ranging from 7-9, depending on the plant and particular compound. However, BIOX-F was applied to soybean plants at much higher iron concentrations (0.094% - 0.376% by weight) without toxic effects (see Example 11).

TABLE 2
Tomato and bell pepper toxicity assessment at 1
week after treatment with foliar micronutrients.

| | | Tomato | Pepper |
|---|---|---|---|
| Products | Rates | toxicity | toxicity |
| BIOX-Z | Low | 0 | 0 |
| | Medium | 0 | 0 |
| | High | 0 | 0 |
| BIOX-Cu | Low | 0 | 0 |
| | Medium | 0 | 0 |
| | High | 0 | 0 |
| BIOX-M | Low | 0 | 0 |
| | Medium | 0 | 0 |
| | High | 0 | 0 |
| BIOX-INC | Low | 0 | 0 |
| | Medium | 0 | 0 |
| | High | 0 | 0 |
| BIOX-INI | Low | 7 | 7 |
| | Medium | 7 | 7 |
| | High | 7 | 7 |
| BIOX-INZ | Low | 0 | 0 |
| | Medium | 0 | 0 |
| | High | 0 | 0 |
| BIOX-GZ | Low | 0 | 0 |
| | Medium | 0 | 0 |
| | High | 0 | 0 |
| BIOX-GC | Low | 7 | 7 |
| | Medium | 7 | 7 |
| | High | 7 | 7 |
| BIOX-GF | Low | 0 | 0 |
| | Medium | 0 | 0 |
| | High | 0 | 0 |
| BIOX-GM | Low | 7 | 7 |
| | Medium | 7 | 7 |
| | High | 7 | 7 |
| BIOX-MEZ | Low | 0 | 0 |
| | Medium | 0 | 0 |
| | High | 0 | 0 |
| BIOX-EDC | Low | 8 | 8 |
| | Medium | 8 | 8 |
| | High | 8 | 8 |
| BIOX-EDZ | Low | 0 | 0 |
| | Medium | 0 | 0 |
| | High | 0 | 0 |
| BIOX-EDI | Low | 8 | 9 |
| | Medium | 8 | 9 |
| | High | 8 | 9 |
| CONTROL | Low | 0 | 0 |
| | Medium | 0 | 0 |
| | High | 0 | 0 |

Toxicity scale is 0 = no visible injury and 10 = plant death.

### Example 2

### Foliar Nutrient Concentration

There were no significant effects (P>0.05) of the products or the applied rates on the foliar concentration of N, P, K, Mg, Ca, S, and B in tomato and bell pepper. The average values per product were 6.2%, 1.0%, 6.1%, 0.6%, 1.2%, 1.0%, and 37.7 ppm of N, P, K, Ca, Mg, S, and B, respectively, which corresponded to normal values for tomato during that growing stage. The same effect occurred with bell pepper (6.1% N, 0.9% P, 6.0% K, 0.6% Mg, 1.2% Ca, 1.0% S, and 38.3 ppm B). The comparison between the non-treated control and each treated plot resulted in significant differences in foliar concentrations. The treatment with BIOX-Z had Zn concentrations approximately 3 times higher than the non-Zn control. BIOX-M provided between 2.4 and 3 times more foliar Mn than the non-Mn control. A similar situation was observed with the Cu-based application BIOX-Cu, which provided about 4 times more foliar Cu than the non-Cu control.

### Example 3

### Marketable Yield

Tomato and bell pepper yields significantly increased (P<0.05) with the foliar applications of BIOX-Z, BIOX-Cu, BIOX-M, and BIOX-MEZ, which were treatments that did not produce plant injury (Table 3). There were no significant effects of rates on marketable yield, which indicated that the lowest rates were enough to satisfy crop demands.

TABLE 3
Marketable yield per plant

| | |
|---|---|
| Tomato | Pepper |

| | |
|---|---|
| Products | lb/plant |

| | | |
|---|---|---|
| Control | 0.7 | 0.4 |
| BIOX-Z | 2.9* | 2.9* |
| BIOX-Cu | 5.5* | 4.0* |
| BIOX-M | 5.8* | 3.9* |
| BIOX-MEZ | 3.0* | 3.2* |

*= significant difference from control

### Materials and Methods for Examples 4-6

The following experiments were performed in a green house during the fall of 2008 and spring of 2009 at GCREC, Balm, University of Florida. Crop set-up, procedures and variables were as follows.

Transplants of Tygress' tomato plants were planted in 2-gallon pots filled with commercial planting medium with nutrient concentration of Fe, Zn, Mn, Cu being negligible and insufficient for crop growth. Irrigation and non-micronutrient fertilizer were provided daily through microsprinklers at recommended rates for tomato production in Florida. No pesticides were used. Treatments were as described in Tables 4, 5 and 6 below. BIOX-INM and BIOX-EDM compared to BIOX-M; BIOX-INZ and BIOX-EDZ were compared with BIOX-Z.

TABLE 4
Mn treatments applied to tomato plants

| | |
|---|---|
| Rates of Mn | Rates of product |
| application | application |

| | | |
|---|---|---|
| Products | lb/acre/season | mg/plant |

| | | | |
|---|---|---|---|
| BIOX-M (16% Mn) | 0.31 | 1.9 | 198 |
| | 0.62 | 3.8 | 396 |
| | 1.23 | 7.7 | 803 |
| | 2.46 | 15.4 | 1605 |
| BIOX-EDM (13%) | 2.0 | 15.4 | 1605 |
| BIOX-INM (26% Mn) | 1.0 | 3.8 | 395 |
| CONTROL | 0 | 0 | 0 |

TABLE 5
Zn treatments applied to tomato plants

| | |
|---|---|
| Rates of Zn | Rates of product |
| application | application |

| | | |
|---|---|---|
| Products | lb/acre/season | mg/plant |

| | | | |
|---|---|---|---|
| BIOX-Z (18% Zn) | 0.1 | 0.6 | 63 |
| | 0.2 | 1.2 | 125 |
| | 0.4 | 2.4 | 250 |
| | 0.8 | 4.8 | 500 |
| BIOX-INZ (34% Zn) | 0.8 | 2.4 | 250 |
| BIOX-EDZ (14.7%) | 0.4 | 2.7 | 281 |
| CONTROL | 0 | 0 | 0 |

TABLE 6
BIOX-A treatments applied to tomato plants

Rates of product
application

| Product | lb/acre/season | mg/plant |
|---|---|---|
| BIOX-A | 0.69 | 63 |
| | 1.37 | 125 |
| | 2.86 | 261 |
| | 5.52 | 504 |
| | 8.28 | 756 |
| CONTROL | 0 | 0 |

Treatments were applied at 5 WAT (weeks after transplanting) using a water volume of 200 mL/plant. A non-ionic surfactant was added. Foliar tissue analysis was performed at 3 and 7 WAT on the non-applied newest leaves. The concentrations of N, P, K, Mg, Ca, B, Zn, Mn, Fe, and Cu in the foliar tissue were determined from foliar analysis by a commercial laboratory at 2 weeks before treatment and again at 2 weeks after treatment. Nutrient concentrations in the leaves 2 weeks before treatment (3 WAT) are shown in Table 7. There were no significant differences between the foliar nutrient concentration of the leaves of any of the treatment groups prior to treatment.

TABLE 7
Nutrient concentrations in tomato leaves 2 weeks prior to treatment

| N | P | K | Mg | Ca | B | Zn | Mn | Fe | Cu |
|---|---|---|---|---|---|---|---|---|---|
| % | | | | | ppm | | | | |
| 3.5 | 0.5 | 3.2 | 0.3 | 0.6 | 19 | 26 | 15 | 110 | 5 |

Deionized water was used for foliar applications, and other nutrients were applied as appropriate under non-limiting conditions. Marketable fruit were collected three times during the growing season, starting at 10 WAT (5 weeks after the initial treatment). Tomato fruit was graded as extra-large, large and medium. Non-marketable fruit were harvested and number and weight recorded but not sized.

Experimental design was a randomized complete block design with 6 replications. Data were analyzed using a general linear model, and means were separated using an LSD test at the 5% significance level. (Treatments with the same letters following the numerical value are not significantly different.)

### Example 4

### Effect of BIOX-M on Foliar Tutrient Concentration and Tomato Yield

Foliar nutrient concentrations in leaves of tomato plants treated with various concentrations of BIOX-M and controls are shown in Table 8. None of the applied Mn supplementation compounds had a significant effect (P>0.05) on the foliar concentration of N, P, K, Mg, Ca, B, Zn, Fe and Cu at any of the applied rates.

TABLE 8
Nutrient concentrations in tomato leaves 2 weeks after Mn treatment

| | Rates of Mn | | | | | | | | | |
|---|---|---|---|---|---|---|---|---|---|---|
| | application | N | P | K | Mg | Ca | B | Zn | Fe | Cu |
| Products | lb/acre | % | | | | ppm | | | | |
| BIOX-M | 0.31 | 3.5 | 0.4 | 3.1 | 0.3 | 0.6 | 22 | 31 | 109 | 5 |
| (16% Mn) | | | | | | | | | | |
| | 0.62 | 3.5 | 0.5 | 3.2 | 0.3 | 0.6 | 24 | 32 | 110 | 5 |
| | 1.23 | 3.5 | 0.5 | 3.1 | 0.3 | 0.6 | 25 | 28 | 112 | 5 |
| | 2.46 | 3.6 | 0.4 | 3.2 | 0.3 | 0.6 | 23 | 33 | 114 | 5 |
| BIOX-EDM | 2.0 | 3.3 | 0.5 | 3.3 | 0.3 | 0.6 | 22 | 32 | 115 | 5 |
| (13% Mn) | | | | | | | | | | |
| BIOX-INM | 1.0 | 3.4 | 0.6 | 3.2 | 0.3 | 0.6 | 25 | 34 | 117 | 5 |
| (26% Mn) | | | | | | | | | | |
| CONTROL | 0 | 3.5 | 0.5 | 3.3 | 0.3 | 0.6 | 24 | 31 | 115 | 5 |

| | | | | | | | | | |
|---|---|---|---|---|---|---|---|---|---|
| Significance (P < 0.05) | NS | NS | NS | NS | NS | NS | NS | NS | NS |

TABLE 9
Mn concentrations in tomato leaves 2 weeks after Mn treatment

| | Rates of Mn | Foliar Mn |
|---|---|---|
| | application | concentration |
| Products | lb/acre | ppm |
| BIOX-M (16% Mn) | 0.31 | 22.9 b |
| | 0.62 | 29.5 b |
| | 1.23 | 60.6 a |
| | 2.46 | 69.2 a |
| BIOX-EDM (13% Mn) | 2.0 | 78.5 a |
| BIOX-INM (26% Mn) | 1.0 | 80.9 a |
| CONTROL | 0 | 19.4 b |

| | |
|---|---|
| Significance (P < 0.05) | * |

All treatments resulted in significantly higher marketable yields per plant than the non-treated control, as shown in Table 10. Plants treated with BIOX-M at rates of 1.23 lb/acre or more resulted in similar marketable tomato yields as BIOX-EDM treatment at 2.0 lb/acre and Mn-sulfate treatment at 1.0 lb/acre, all of which were significantly higher than the non-treated control. The non-marketable yields per plant for all treatments were statistically indistinguishable from control.

TABLE 10
Yields of tomato fruits

| | Rates of Mn | Market- | Non-Marketable | |
|---|---|---|---|---|
| | application | able yield | yield | |
| Products | lb/acre | lb/plant | lb/plant | no./plant |
| BIOX-M (16% Mn) | 0.31 | 2.2 b | <0.5 | 1 |
| | 0.62 | 2.1 b | <0.5 | 1 |
| | 1.23 | 4.2 a | <0.5 | 2 |
| | 2.46 | 4.3 a | <0.5 | 1 |
| BIOX-EDM (13% Mn) | 2.0 | 4.4 a | <0.5 | 2 |
| BIOX-INM (26% Mn) | 1.0 | 4.0 a | <0.5 | 1 |
| CONTROL | 0 | 2.1 b | <0.5 | 1 |

| | | | |
|---|---|---|---|
| Significance (P < 0.05) | * | NS | NS |

### Example 5

### Effect of BIOX-Z on Foliar Nutrient Concentration and Tomato Yield

Foliar nutrient concentrations in the leaves of tomato plants treated with the Zn supplementation treatments are shown in Table 11. None of the applied Zn supplementation compounds had a significant effect (P>0.05) on the foliar concentration of N, P, K, Mg, Ca, B, Mn, Fe and Cu at any of the applied rates. Table 12 summarizes the foliar Zn concentration measured 2 weeks after the application of the Zn supplementation treatments. When applied at a concentration of 0.8 lb/acre, the BIOX-Z treatment resulted in a foliar Zn concentration that was significantly higher than control, and was similar to the foliar Zn concentration of the plants treated with BIOX-INZ.

TABLE 11
Nutrient concentrations in tomato leaves 2 weeks after Zn treatment

| | Rates of Zn | | | | | | | | | |
|---|---|---|---|---|---|---|---|---|---|---|
| | application | N | P | K | Mg | Ca | B | Mn | Fe | Cu |
| Products | lb/acre | % | | | | | ppm | | | |
| BIOX-Z (18% | 0.1 | 3.6 | 0.5 | 3.5 | 0.3 | 0.6 | 25 | 55 | 98 | 8 |
| Zn) | 0.2 | 3.3 | 0.5 | 3.7 | 0.3 | 0.6 | 27 | 56 | 88 | 6 |
| | 0.4 | 3.4 | 0.5 | 3.5 | 0.3 | 0.6 | 28 | 59 | 88 | 6 |
| | 0.8 | 3.5 | 0.5 | 3.4 | 0.3 | 0.5 | 25 | 54 | 93 | 4 |
| BIOX-INZ | 0.8 | 3.6 | 0.4 | 3.5 | 0.3 | 0.6 | 24 | 55 | 97 | 5 |
| (34% Zn) | | | | | | | | | | |
| BIOX-EDZ | 0.4 | 3.6 | 0.5 | 3.6 | 0.3 | 0.6 | 21 | 54 | 95 | 7 |
| (14.7% Zn) | | | | | | | | | | |
| CONTROL | 0 | 3.5 | 0.5 | 3.5 | 0.3 | 0.6 | 26 | 56 | 99 | 6 |

| | | | | | | | | | |
|---|---|---|---|---|---|---|---|---|---|
| Significance (P < 0.05) | NS | NS | NS | NS | NS | NS | NS | NS | NS |

TABLE 12
Zn concentrations in tomato leaves 2 weeks after Zn treatment

| | Rates of Zn | Foliar Zn |
|---|---|---|
| | application | concentration |
| Products | lb/acre | ppm |
| BIOX-Z (18% Zn) | 0.1 | 86 bc |
| | 0.2 | 112 bc |
| | 0.4 | 128 bc |
| | 0.8 | 500 ab |
| BIOX-INZ (34% Zn) | 0.8 | 768 a |
| BIOX-EDZ (14.7% Zn) | 0.4 | 214.bc |
| CONTROL | 0 | 26 c |

| | |
|---|---|
| Significance (P < 0.5) | * |

All Zn supplementation treatments resulted in higher marketable yields than control, as shown in Table 13. The yields from those plants treated using BIOX-Z at a concentration higher than 0.1 lb/acre were statistically similar to the other Zn supplementation treatment formulations. The non-marketable yields for all treatments were statistically indistinguishable from control.

TABLE 13
Yields of tomato fruits

| | Rate of Zn | Market- | Non-Marketable | |
|---|---|---|---|---|
| | application | able yield | yield | |
| Products | lb/acre | lb/plant | lb/plant | no./plant |
| BIOX-Z (18% Zn) | 0.1 | 2.3 b | <0.5 | 2 |
| | 0.2 | 3.7 a | <0.5 | 1 |
| | 0.4 | 3.9 a | <0.5 | 2 |
| | 0.8 | 3.8 a | <0.5 | 2 |
| BIOX-INZ (34% Zn) | 0.8 | 3.7 a | <0.5 | 2 |
| BIOX-EDZ (14.7% Zn) | 0.4 | 3.5 a | <0.5 | 2 |
| CONTROL | 0 | 1.8 c | <0.5 | 1 |

| | | | |
|---|---|---|---|
| Significance (P < 0.5) | * | NS | NS |

### Example 6

### Effect of BIOX-A on Foliar Nutrient Concentration and Tomato Yield

Foliar nutrient concentrations in the leaves of tomato plants treated with the BIOX-A supplementation treatments are shown in Table 14. None of the applied concentrations of BIOX-A had a significant effect (P>0.05) on the foliar concentration of N, P, K, Mg, Ca, B, Mn, Fe and Zn relative to the control.

TABLE 14
Nutrient concentrations in tomato leaves 2 weeks after BIOX-A treatment

| | Rate | | | | | | | | | |
|---|---|---|---|---|---|---|---|---|---|---|
| | of application | N | P | K | Mg | Ca | B | Mn | Fe | Cu |
| Products | lb/acre | % | | | | | ppm | | | |
| BIOX-A | 0.69 | 3.4 | 0.6 | 3.2 | 0.3 | 0.5 | 27 | 56 | 85 | 29 |
| | 1.37 | 3.7 | 0.4 | 3.4 | 0.3 | 0.6 | 28 | 55 | 88 | 31 |
| | 2.86 | 3.1 | 0.4 | 3.3 | 0.1 | 0.6 | 28 | 54 | 87 | 50 |
| | 5.52 | 2.7 | 0.5 | 2.1 | 0.1 | 0.6 | 24 | 53 | 90 | 28 |
| | 8.28 | 1.7 | 0.6 | 0.9 | 0.1 | 0.5 | 25 | 57 | 9 | 25 |
| CONTROL | 0 | 3.5 | 0.5 | 3.4 | 0.3 | 0.6 | 24 | 52 | 88 | 23 |

| | | | | | | | | | |
|---|---|---|---|---|---|---|---|---|---|
| Significance (P < 0.05) | * | NS | * | * | NS | NS | NS | NS | NS |

Marketable tomato yields significantly decreased (P<0.05) with the foliar applications of BIOX-A at concentrations of 2.86 or higher. The application of BIOX-A at these higher concentrations severely injured tomato plants, and also resulted in significantly higher non-marketable tomato yields than control. Both marketable and unmarketable yields of the plants treated with 1.37 lb/acre or less of BIOX-A were statistically similar.

TABLE 15
Yields of tomato fruits

| | Rates of | Market- | | Non-marketable | |
|---|---|---|---|---|---|
| | application | able yield | | yield | |
| Product | lb/acre | lb/plant | | lb/plant | no./plant |
| BIOX-A | 0.69 | 2.3 | a | <0.5 | 2 |
| | 1.37 | 2.4 | a | <0.5 | 3 |
| | 2.86 | 1.1 | b | 4.1 | 10 |
| | 5.52 | 0 | b | 3.7 | 11 |
| | 8.28 | 0 | b | 1.5 | 5 |
| CONTROL | 0 | 2.2 | a | <0.5 | 2 |

| | | | |
|---|---|---|---|
| Significance (P < 0.5) | * | * | * |

### Materials and Methods for Examples 7-10

The following experiments were performed in open-field plots during the spring of 2008 at GCREC, Balm, University of Florida. Four products delivering Zn (BIOX-Z), Mn (BIOX-M), Cu (BIOX-Cu), and Fe (BIOX-Fe) were compared to other micronutrient supplement formulations in tomato and bell pepper plants.

The plot sizes for the tomato plants were 30-ft plots (15 plants per plot) and 15-ft plots were used for the bell pepper plants (30 plants per plot). Crop set-up, procedures and variables were as follows.

Transplants of ‘Tygress’ tomato plants and ‘Patriot’ bell pepper plants in the 4-true leaf stage (about 6 inches tall) were planted in raised beds in open-field plots. The cross-section of each raised bed was 28 inches wide at the top, 32 inches wide at the base, and 8 inches tall. Irrigation and non-micronutrient fertilizer were provided daily through two drip lines per bed (0.45 gal/100 ft bed/min) at recommended rates for tomato and bell pepper production in Florida. Foliar pesticides were applied as needed, taking care to select pesticide compositions that did not confound the effects of the foliar micronutrient treatments. The height of the plants for each of the treatment groups was measured at 3 weeks after transplantation (WAT), just prior to treatment with the experimental foliar fertilizers. The mean plants heights are summarized in Table 16.

TABLE 16
Plant heights at 3 weeks after transplantation (pre-treatment)

| | |
|---|---|
| Tomato | Bell pepper |

| | |
|---|---|
| Product | Plant height (cm) |

| | | |
|---|---|---|
| BIOX-Z | 39 | 15 |
| BIOX-Cu | 39 | 17 |
| BIOX-M | 38 | 16 |
| BIOX-Fe | 40 | 16 |
| BIOX-INC | 39 | 14 |
| BIOX-INZ | 36 | 17 |
| BIOX-CM | 37 | 16 |
| BIOX-GZ | 38 | 13 |
| BIOX-GF | 40 | 15 |
| BIOX-EDZ | 38 | 16 |
| BIOX-EDM | 40 | 16 |
| Control | 38 | 17 |
| Significance | NS | NS |

All foliar fertilizers except BIOX-CM were applied to the various treatment groups at 3 weeks after transplantation (WAT) and again at 5 WAT. The BIOX-CM treatment was applied at 4 and 5 WAT. The working water volume was 60 gal/acre and a non-ionic surfactant (Ad-Spray 80) was added in the amount of 2 pints/100 gal water. All plots were sprayed with sprayers pressurized at 25 psi and the canopies of both crops were covered with the micronutrient solutions. Treated plots were isolated during foliar fertilizer application to avoid the cross-contamination of other treatments on adjoining plots. The foliar fertilizers were applied at the rates summarized in Table 17.

TABLE 17
Rates of micronutrient treatments applied
to tomato and bell pepper plants

| | |
|---|---|
| Tomato | Bell pepper |

| | |
|---|---|
| | Application rate |
| Product | (lb/acre/season) |

| | | |
|---|---|---|
| BIOX-Z | 1.3 | 1.3 |
| BIOX-Cu | 6.7 | 6.7 |
| BIOX-M | 23.0 | 23.0 |
| BIOX-Fe | 3.2 | 3.2 |
| BIOX-INC | 4.0 | 4.0 |
| BIOX-INZ | 0.6 | 0.6 |
| BIOX-CM | 10.0 | 10.0 |
| BIOX-GZ | 1.0 | 1.0 |
| BIOX-GF | 4.0 | 4.0 |
| BIOX-EDZ | 1.4 | 1.4 |
| BIOX-EDM | 23.0 | 23.0 |
| Control | — | — |

Leaf samples were collected from the most recent mature leaves from each plant at 6 WAT (2 weeks after initial treatment). Foliar tissue analysis was performed by a commercial laboratory to determine the concentration of N, P, K, Mg, Ca, B, Zn, Mn, Fe, and Cu. Tomato marketable fruit weights were collected at 10 and 12 WAT, and the fruits were graded according to USDA standards. Pepper marketable fruit weights were determined beginning at 5 WAT over 5 weekly harvests. Fruit mineral analysis (N, P, K, Mg, Ca, B, Zn, Mn, Fe, and Cu) was performed on samples from the tomato harvest.

The experimental design was a randomized complete block design with 5 replications for each treatment. All comparison data were analyzed using a general linear model and the means of each treatment were separated with a Fisher's protected LSD test at the 5% significance level.

### Example 7

### Effect of BIOX-Z on Foliar Nutrient Concentration and Fruit Yields for Tomato and Bell Pepper Plants

The tomato leaf nutrient foliar nutrient concentrations in the tomato plants measured 6 weeks after transplantation (WAT) are summarized for the control group and all Zn supplementation treatment groups in Table 18. None of the foliar nutrient concentrations except for Zn were affected by any of the treatments. Treatment with BIOX-Z and BIOX-INZ resulted in the highest foliar concentration of Zn at 6 WAT. A slightly higher foliar Zn concentration at 6 WAT resulted from treatment with BIOX-GC as well. All treatments except BIOX-EDZ resulted in significantly higher foliar Zn concentrations at 6 WAT compared to control.

TABLE 18
Foliar nutrient concentration of tomato plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Z | 4.7 | 0.21 | 5.5 | 0.78 | 2.2 | 59 | 434 a | 198 | 76 | 338 |
| BIOX- | 4.8 | 0.18 | 5.7 | 0.58 | 1.9 | 41 | 323 ab | 231 | 71 | 358 |
| INZ | | | | | | | | | | |
| BIOX-GZ | 4.6 | 0.22 | 5.0 | 0.61 | 1.8 | 44 | 369 b | 278 | 94 | 482 |
| BIOX- | 4.9 | 0.24 | 5.2 | 0.69 | 1.9 | 44 | 310 bc | 207 | 90 | 371 |
| EDZ | | | | | | | | | | |
| Control | 4.9 | 0.23 | 4.8 | 0.54 | 1.6 | 37 | 253 c | 216 | 80 | 361 |
| Signifi- | NS | NS | NS | NS | NS | NS | * | NS | NS | NS |
| cance | | | | | | | | | | |

The bell pepper leaf nutrient foliar nutrient concentrations in the tomato plants measured 6 weeks after transplantation (WAT) are summarized for the control group and all Zn supplementation treatment groups in Table 19. None of the foliar nutrient concentrations except for Zn were affected by any of the treatments. Treatment with BIOX-Z, BIOX-GZ, and BIOX-EDZ resulted in a significantly higher foliar concentration of Zn at 6 WAT compared to control.

TABLE 19
Foliar nutrient concentration of bell pepper plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Z | 4.2 | 0.25 | 3.7 | 0.50 | 4.4 | 62 | 220 a | 240 | 121 | 387 |
| BIOX- | 3.9 | 0.22 | 3.2 | 0.53 | 4.6 | 57 | 64 b | 303 | 116 | 385 |
| INZ | | | | | | | | | | |
| BIOX-GZ | 4.4 | 0.24 | 3.4 | 0.49 | 4.2 | 59 | 145 a | 282 | 118 | 429 |
| BIOX- | 4.2 | 0.24 | 3.2 | 0.47 | 4.2 | 59 | 234 a | 284 | 121 | 421 |
| EDZ | | | | | | | | | | |
| Control | 4.5 | 0.27 | 3.4 | 0.46 | 3.7 | 65 | 38 b | 312 | 116 | 430 |
| Signifi- | NS | NS | NS | NS | NS | NS | * | NS | NS | NS |
| cance | | | | | | | | | | |

The marketable yields for the tomato and bell pepper plants grown with the various Zn supplementation treatments are summarized in Table 20. Each of the treatments had similar effects on the tomato harvests. However, treatment with BIOX-Z, BIOX-GZ, and BIOX-EDZ resulted in tomato harvests that were significantly higher than the control tomato harvest. None of the treatments had a significant effect on the bell pepper harvest.

TABLE 20
Marketable yields from tomato and bell pepper plants

| | Marketable yield (ton/acre) | | |
|---|---|---|---|
| Product | | Tomato | Bell Pepper |

| | | | |
|---|---|---|---|
| BIOX-Z | 17.5 | a | 8.4 |
| BIOX-INZ | 15.6 | ab | 6.9 |
| BIOX-GZ | 16.8 | a | 6.3 |
| BIOX-EDZ | 16.2 | a | 8.1 |
| Control | 13.6 | b | 7.3 |

| | | |
|---|---|---|
| Significance | * | NS |

The micronutrient concentrations of the harvested tomato fruits are summarized for the control group and all Zn supplementation treatment groups in Table 21. None of the foliar nutrient concentrations in the tomato fruits were affected by any of the treatments.

TABLE 21
Nutrient concentration of tomato fruits at 10 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Z | 4.3 | 0.63 | 8.0 | 0.36 | 0.2 | 20 | 308 | 38 | 82 | 21 |
| BIOX-INZ | 4.2 | 0.59 | 7.5 | 0.34 | 0.2 | 21 | 496 | 38 | 85 | 21 |
| BIOX-GZ | 4.3 | 0.61 | 7.8 | 0.37 | 0.2 | 23 | 379 | 43 | 87 | 23 |
| BIOX-EDZ | 4.4 | 0.66 | 8.5 | 0.37 | 0.2 | 22 | 1018 | 43 | 82 | 23 |
| Control | 4.3 | 0.69 | 8.0 | 0.37 | 0.2 | 22 | 446 | 43 | 86 | 21 |
| Significance | NS | NS | NS | NS | NS | NS | NS | NS | NS | NS |

The results of this experiment demonstrated that only BIOX-Z was associated with both a significantly higher foliar Zn content, and a higher marketable yield compared to control. However, none of the supplemental Zn compositions was associated with a higher Zn concentration in the resulting tomato fruit. All of the treatments except BIOX-INZ were associated with significantly higher bell pepper marketable yields compared to control. However, none of the treatments had a significant effect on any foliar nutrient concentration of the bell pepper plants, including Zn.

### Example 8

### Effect of BIOX-M on Foliar Nutrient Concentration and Fruit Yields for Tomato and Bell Pepper Plants

The tomato leaf nutrient foliar nutrient concentrations in the tomato plants measured 6 weeks after transplantation (WAT) are summarized for the control group and all Mn supplementation treatment groups in Table 22. Treatment of the tomato plant with BIOX-M was associated with a significant increase in the foliar concentration of P and Mn compared to control at 6 WAT. Treatment with BIOX-EDM was associated with a significant decrease in the foliar concentration of P, and a significant increase in the foliar concentration of K, Zn, and Mn at 6 WAT. Treatment with BIOX-CM was associated with a significantly higher foliar concentration of Mn compared to control at 6 WAT. The highest foliar concentration of Mn was associated with treatment of the tomato plant with BIOX-M.

TABLE 22
Foliar nutrient concentration of tomato plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-M | 4.4 | 0.19 b | 4.6 b | 0.56 | 1.7 | 70 | 266 b | 470 a | 88 | 417 |
| BIOX-CM | 5.1 | 0.24 a | 5.0 b | 0.66 | 1.8 | 43 | 242 b | 272 b | 85 | 326 |
| BIOX-EDM | 4.9 | 0.22 ab | 6.2 a | 0.82 | 2.2 | 60 | 333 a | 348 b | 100 | 409 |
| Control | 4.9 | 0.23 a | 4.8 b | 0.56 | 1.6 | 37 | 253 b | 216 c | 80 | 361 |
| Significance | * | * | NS | NS | NS | NS | * | * | NS | NS |

The bell pepper leaf nutrient foliar nutrient concentrations in the tomato plants measured 6 weeks after transplantation (WAT) are summarized for the control group and all Mn supplementation treatment groups in Table 23. None of the foliar nutrient concentrations were affected by any of the treatments.

TABLE 23
Foliar nutrient concentration of bell pepper plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-M | 4.4 | 0.25 | 3.4 | 0.52 | 4.2 | 59 | 63 | 436 | 124 | 462 |
| BIOX-CM | 4.3 | 0.23 | 3.6 | 0.47 | 4.2 | 63 | 44 | 594 | 121 | 364 |
| BIOX-EDM | 4.4 | 0.28 | 3.6 | 0.52 | 4.4 | 64 | 67 | 563 | 138 | 411 |
| Control | 4.5 | 0.27 | 3.4 | 0.46 | 3.7 | 65 | 38 | 312 | 116 | 430 |
| Significance | NS | NS | NS | NS | NS | NS | NS | NS | NS | NS |

The marketable yields for the tomato and bell pepper plants grown with the various Mn supplementation treatments are summarized in Table 24. Only treatment with BIOX-M was associated with a significantly higher marketable yield of tomato fruits. None of the treatments had a significant effect on the bell pepper marketable yield.

TABLE 24
Marketable yields from tomato and bell pepper plants

Marketable yield (ton/acre)

| Product | Tomato | Bell Pepper |
|---|---|---|
| BIOX-M | 18.1 a | 6.3 |
| BIOX-CM | 13.9 b | 8.0 |
| BIOX-EDM | 14.6 b | 7.6 |
| Control | 13.6 b | 7.3 |
| Significance | * | NS |

The micronutrient concentrations of the harvested tomato fruits at 10 WAT are summarized for the control group and all Mn supplementation treatment groups in Table 25. Only BIOX-EDM was associated with significant increases in micronutrient concentrations of Zn, Mn, Fe, and Cu in the tomato fruits at 10 WAT.

TABLE 25
Nutrient concentration of tomato fruits at 10 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX- | 4.2 | 0.65 | 8.0 | 0.37 | 0.2 | 23 | 209 b | 43 b | 81 b | 23 b |
| M | | | | | | | | | | |
| BIOX- | 4.2 | 0.57 | 7.9 | 0.37 | 0.2 | 22 | 217 b | 40 b | 73 b | 21 b |
| CM | | | | | | | | | | |
| BIOX- | 4.3 | 0.63 | 8.6 | 0.39 | 0.2 | 24 | 939 a | 60 a | 110 a | 27 a |
| EDM | | | | | | | | | | |
| Control | 4.3 | 0.69 | 8.0 | 0.37 | 0.2 | 22 | 446 ab | 43 b | 86 b | 21 b |
| Signifi- | NS | NS | NS | NS | NS | NS | * | * | * | * |
| cance | | | | | | | | | | |

The results of this experiment demonstrated that BIOX-M was associated with both a significantly higher foliar Mn content, and a higher marketable yield of tomato fruits compared to control. However, the BIOX-EDM treatment of the tomato plants was associated with the highest Mn concentration in the resulting tomato fruit. None of the treatments had a significant effect on any foliar nutrient concentration of the bell pepper plants, including Mn.

### Example 9

### Effect of BIOX-Cu on Foliar Nutrient Concentration and Fruit Yields for Tomato and Bell Pepper Plants

The tomato leaf nutrient foliar nutrient concentrations in the tomato plants measured 6 weeks after transplantation (WAT) are summarized for the control group and all Cu supplementation treatment groups in Table 22. None of the foliar nutrient concentrations except for Cu were affected by any of the treatments. Only treatment with BIOX-INC resulted in a significant increase in the foliar concentration of Cu at 6 WAT compared to control.

TABLE 26
Foliar nutrient concentration of tomato plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Cu | 5.0 | 0.21 | 5.6 | 0.58 | 1.8 | 42 | 306 | 211 | 83 | 407 b |
| BIOX-INC | 4.7 | 0.17 | 5.3 | 0.60 | 2.0 | 40 | 281 | 208 | 71 | 503 a |
| Control | 4.9 | 0.23 | 4.8 | 0.56 | 1.6 | 37 | 253 | 216 | 80 | 361 b |
| Significance | NS | NS | NS | NS | NS | NS | NS | NS | NS | * |

The bell pepper nutrient foliar nutrient concentrations in the bell pepper measured 6 weeks after transplantation (WAT) are summarized for the control group and all Cu supplementation treatment groups in Table 27. None of the foliar nutrient concentrations except for Cu were affected by any of the treatments. Only treatment with BIOX-INC resulted in a significant increase in the foliar concentration of Cu at 6 WAT compared to control.

TABLE 27
Foliar nutrient concentration of bell pepper plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Cu | 5.0 | 0.21 | 5.6 | 0.58 | 1.8 | 42 | 306 | 211 | 83 | 407 b |
| BIOX-INC | 4.7 | 0.17 | 5.3 | 0.60 | 2.0 | 39 | 281 | 208 | 71 | 503 a |
| Control | 4.9 | 0.23 | 4.8 | 0.56 | 1.6 | 37 | 253 | 216 | 80 | 361 b |
| Significance | NS | NS | NS | NS | NS | NS | NS | NS | NS | * |

The marketable yields for the tomato and bell pepper plants grown with the various Cu supplementation treatments are summarized in Table 28. Both treatment with BIOX-Cu and BIOX-INC resulted in significantly increased tomato marketable yields relative to control. Neither Cu supplementation had a significant effect on the bell pepper marketable yield compared to the control group.

TABLE 28
Marketable yields from tomato and bell pepper plants

Marketable yield (ton/acre)

| Product | Tomato | Bell Pepper |
|---|---|---|
| BIOX-Cu | 19.2 a | 7.8 |
| BIOX-INC | 17.4 a | 7.3 |
| Control | 13.6 b | 7.3 |
| Significance | * | NS |

The micronutrient concentrations of the harvested tomato fruits are summarized for the control group and the Cu supplementation treatment groups in Table 29. None of the foliar nutrient concentrations in the tomato fruits were affected by any of the treatments.

TABLE 29
Nutrient concentration of tomato fruits at 10 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Cu | 4.4 | 0.67 | 8.5 | 0.39 | 0.2 | 21 | 294 | 37 | 77 | 21 |
| BIOX-INC | 4.4 | 0.68 | 8.0 | 0.38 | 0.2 | 21 | 332 | 42 | 85 | 22 |
| Control | 4.3 | 0.69 | 8.0 | 0.37 | 0.2 | 22 | 446 | 43 | 86 | 21 |
| Significance | NS | NS | NS | NS | NS | NS | NS | NS | NS | NS |

The results of this experiment demonstrated that both BIOX-Cu and BIOX-INC were associated with a significantly higher marketable yield of tomato fruits compared to control. However, neither of the supplemental Cu compositions was associated with a higher Cu concentration in the resulting tomato fruit, and neither of the treatments was associated with significantly higher bell pepper marketable yields compared to control. In addition, neither of the Cu supplementation treatments had a significant effect on any foliar nutrient concentration of the bell pepper plants, including Cu.

### Example 10

### Effect of BIOX-Fe on Foliar Nutrient Concentration and Fruit Yields for Tomato and Bell Pepper Plants

The tomato leaf nutrient foliar nutrient concentrations in the tomato plants measured 6 weeks after transplantation (WAT) are summarized for the control group and all Fe supplementation treatment groups in Table 30. None of the foliar nutrient concentrations were affected by either Fe supplementation treatments.

TABLE 30
Foliar nutrient concentration of tomato plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Fe | 4.2 | 0.69 | 8.2 | 0.37 | 0.2 | 21 | 294 | 37 | 77 | 21 |
| BIOX-GF | 4.3 | 0.71 | 8.5 | 0.38 | 0.2 | 21 | 332 | 42 | 85 | 22 |
| Control | 4.3 | 0.69 | 8.0 | 0.37 | 0.2 | 22 | 446 | 43 | 86 | 21 |
| Significance | NS | NS | NS | NS | NS | NS | NS | NS | NS | NS |

The bell pepper leaf nutrient foliar nutrient concentration measured 6 weeks after transplantation (WAT) is summarized for the control group and both Fe supplementation treatment groups in Table 31. None of the foliar nutrient concentrations were affected by either treatment.

TABLE 31
Foliar nutrient concentration of bell pepper plants at 6 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Fe | 5.0 | 0.20 | 6.0 | 0.66 | 2.2 | 39 | 318 | 251 | 112 | 369 |
| BIOX-GF | 5.0 | 0.21 | 5.7 | 0.58 | 1.8 | 43 | 322 | 266 | 305 | 453 |
| Control | 4.9 | 0.23 | 4.8 | 0.56 | 1.6 | 37 | 253 | 216 | 80 | 361 |
| Signifi- | NS | NS | NS | NS | NS | NS | NS | NS | NS | NS |
| cance | | | | | | | | | | |

The marketable yields for the tomato and bell pepper plants grown with the Fe supplementation treatments are summarized in Table 32. Both of the Fe supplement treatments similarly increased the tomato marketable yields compared to control. Neither treatment had a significant effect on the bell pepper marketable yield.

TABLE 32
Marketable yields from tomato and bell pepper plants

Marketable yield (ton/acre)

| Product | Tomato | Bell Pepper |
|---|---|---|
| BIOX-Fe | 17.8 a | 7.2 |
| BIOX-GF | 18.5 a | 7.0 |
| Control | 13.6 b | 7.3 |
| Significance | * | NS |

The micronutrient concentrations of the harvested tomato fruits are summarized for the control group and both Fe supplementation treatment groups in Table 33. None of the foliar nutrient concentrations in the tomato fruits were affected by any of the treatments.

TABLE 33
Nutrient concentration of tomato fruits at 10 WAT

| | N | P | K | Mg | Ca | B | Zn | Mn | Fe | Cu |
|---|---|---|---|---|---|---|---|---|---|---|
| Product | concentration (%) | | | | | concentration (ppm) | | | | |
| BIOX-Fe | 4.2 | 0.69 | 8.2 | 0.37 | 0.2 | 21 | 294 | 37 | 77 | 21 |
| BIOX-GF | 4.3 | 0.71 | 8.5 | 0.38 | 0.2 | 21 | 332 | 42 | 85 | 22 |
| Control | 4.3 | 0.69 | 8.0 | 0.37 | 0.2 | 22 | 446 | 43 | 86 | 21 |
| Significance | NS | NS | NS | NS | NS | NS | NS | NS | NS | NS |

The results of this experiment demonstrated that both BIOX-Fe and BIOX-GF were associated with a significantly higher tomato marketable yield compared to control. However, neither of the supplemental Fe compositions had a significant effect relative to control on the Fe concentration in the resulting tomato fruit, bell pepper marketable yield, or foliar nutrient concentration of the tomato or bell pepper plants.

### Materials and Methods for Examples 11 and 12

The following experiments were performed on soybean plants growing in open-field plots during the summer and fall of 2008 at two production fields in West Central Minnesota. The effects of two chelated micronutrient supplementation products BIOX-M and BIOX-Fe were compared with corresponding industrial micronutrient supplementation products (BIOX-INM and BIOX-EDDI) to determine the efficacy of the chelated micronutrient formulations on soybean growth and harvest yield.

Trial design was a randomized complete block with 4 replications. Each plot measured 10′ by 30′ and consisted of five 22″ rows. Although all five rows of each plot were treated, only the center three rows (25′ in length) of each plot were machine harvested. Summary descriptions of the two field sites are summarized in Table 34. The two fields selected for these studies had historical Iron Deficiency Chlorosis (IDC) issues.

TABLE 34
Description of field sites

| | | Soil CaCO₃ | Soil electrical | | |
|---|---|---|---|---|---|
| | Soil | concentration | conductivity | Planting | Harvest |
| Field Site | pH | (g/kg) | (S/m) | date | date |
| Foxhome, MN | 8.2 | 49 g kg⁻¹ | 0.06 S m⁻¹ | May 13, 2008 | Oct. 17, 2008 |
| Renville, MN | 7.6 | 126 g kg⁻¹ | 0.29 S m⁻¹ | May 07, 2008 | Oct. 03, 2008 |

The two field sites were planted by farmers with elite Roundup Ready commodity type soybean varieties with IDC tolerance (Asgrow 1102, Monsanto Corp.). Each of the treatments applied to the plots in the field sites are summarized in Table 35.

TABLE 35
Micronutrient treatments applied to experimental plots

| | | Rate of | Time of application |
|---|---|---|---|
| | | application | (V4 = Jul. 1, 2008, |
| Group # | Product | (kg/ha) | V6 = Jul. 15, 2008) |
| 1 | CONTROL | — | — |
| 2 | BIOX-F | 0.558 | V4 |
| 3 | BIOX-F | 0.558 | V4, V6 |
| 4 | BIOX-F | 1.12 | V4 |
| 5 | BIOX-F | 1.12 | V4, V6 |
| 6 | BIOX-EDDI | 2.23 | V4 |
| 7 | BIOX-EDDI | 2.23 | V4, V6 |
| 8 | BIOX-M | 7.0 | V4 |
| 9 | BIOX-INM | 3.27 | V4 |

BIOX-F was applied at a 1X rate (134 g Fe/ha) for groups 1 and 2, as well as a 2x rate (269 g Fe/ha) for groups 4 and 5. Treatment rates for the BIOX-EDDI were based on the manufacturer's recommended rates for the BIOX-EDDI (Soygreen, West Central, Inc., Willmar, Minn., USA) at the V4 growth stage (4 true leaves open). BIOX-M was applied at a rate of 1.12 kg Mn/ha.

All micronutrient supplements were applied as a foliar treatment on Jul. 1, 2008 when the soybean plants had achieved V4 (four true leaves open). For treatment groups 3, 5, and 7, foliar treatments were applied fourteen days after the V4 treatment, corresponding to approximately V6 for the soybean plants.

All V4 treatments were applied in 10 gallons per acre of water with a backpack sprayer with a hand boom designed to “band” apply product directly to the plant row. Three nozzles with ConeJet TXVS-2 tips were oriented on either side and over the top of each row. This maximized the applied product to the plant tissue itself and minimized application of product to the soil surface. All products were applied in combination with non-ionic surfactant (Cornbelt Premier 90, Van Diest Supply Co., Webster City, Iowa, USA) at 0.5% concentration by mass. The V6 treatments (where applicable) were applied in 20 gallons per acre of water to increase the suspension of the BIOX products.

Visual greenness ratings were measured on 15 and 29 Jul., 2008 at both sites. Greenness was recorded on a 1-5 scale (Cianzio et al., 1979, Crop Sci. 19:644-646) where 1 denotes green/healthy plants and 5 represents significant necrosis.

Newly developed trifoliates were harvested from 10 randomly selected plants from all plots on 29 Jul., 2008. The harvested plants were dried, ground, and subjected to Inductively Coupled Plasma-Mass Spectrometry (ICP-MS) analysis to determine plant micronutrient content.

Soybean seed was harvested after soybean maturity was reached (3 October at Renville, and 17 Oct. 2008 at Foxhome) and seed yields for each experimental treatment group were determined. In addition, seed samples from each treatment were dried to 13% moisture content, then analyzed for protein and oil content.

### Example 11

### Effect of BIOX-F on Soybean Plants

The results of the visual greenness ratings measured from the control plot and the plots supplemented with either BIOX-F or BIOX-EDDI are summarized in Table 36. Significant differences in scores were recorded only at the Foxhome site at the 29 July rating. At this site, both the BIOX-F and BIOX-EDDI supplements provided small but significant increases in greenness as indicated by lower visual greenness score, depending on the rate and timing of application. The BIOX-F treatment applied at the lower rate at V4 had no effect on greenness, but when applied at both V4 and V6, BIOX-F significantly increased the greenness of the soybean plants. When applied at the higher rate at V4 only, BIOX-F significantly increased the greenness in treated plants. However, BIOX-F applied at the higher rate at both V4 and V6 resulted in no change in greenness compared to control. A similar increase in greenness relative to control was observed in the plants treated with BIOX-EDDI, when applied at both V4 and V6, but not when applied at V4 only.

TABLE 36
Visual greenness scores for Fe-supplemented soybean plants

| | | | Mean visual | | | |
|---|---|---|---|---|---|---|
| | | | greenness scores (1-5) | | | |
| | Rate of | | Jul. 15, | | Jul. 29, | |
| | application | Time of | 2008 Rating | | 2008 Rating | |
| Product | (kg/ha) | application | Foxhome | Renville | Foxhome | Renville |
| CONTROL | — | — | 2.8 | 2.9 | 1.6 A, B | 1.6 |
| BIOX-F | 0.558 | V4 | 2.8 | 2.6 | 1.4 B, C | 1.1 |
| BIOX-F | 0.558 | V4, V6 | 2.4 | 2.4 | 1.0 C | 1.1 |
| BIOX-F | 1.12 | V4 | 2.5 | 2.1 | 1.0 C | 1.0 |
| BIOX-F | 1.12 | V4, V6 | 2.6 | 2.6 | 1.5 A, B, C | 1.4 |
| BIOX-EDDI | 2.23 | V4 | 2.8 | 2.6 | 2.0 A | 1.3 |
| BIOX-EDDI | 2.23 | V4, V6 | 2.1 | 2.9 | 1.0 C | 1.4 |

| | | | | |
|---|---|---|---|---|
| significance | NS | NS | * | NS |

The results of the ICP-MS micronutrient content analysis of the trifoliates from the control plot and the plots supplemented with either BIOX-F or BIOX-EDDI are summarized in Table 37. None of the micronutrient treatments resulted in a significant increase in either Fe or Mn at either field location.

TABLE 37
Micronutrient content of Fe-supplemented soybean plants

| | | | Micronutrient content | | | |
|---|---|---|---|---|---|---|
| | Rate of | | from ICP-MS analysis | | | |
| | application | Time of | Foxhome | | Renville | |
| Product | (kg/ha) | application | Mn | Fe | Mn | Fe |
| CONTROL | — | — | 88.55 | 79.73 | 97.60 | 95.26 |
| BIOX-F | 0.558 | V4 | 81.82 | 83.38 | 88.29 | 98.39 |
| BIOX-F | 0.558 | V4, V6 | 76.21 | 88.30 | 96.44 | 96.26 |
| BIOX-F | 1.12 | V4 | 72.70 | 84.93 | 76.15 | 97.42 |
| BIOX-F | 1.12 | V4, V6 | 87.67 | 83.35 | 89.00 | 98.74 |
| BIOX-EDDI | 2.23 | V4 | 91.22 | 82.37 | 86.45 | 96.89 |
| BIOX-EDDI | 2.23 | V4, V6 | 66.03 | 86.15 | 91.09 | 99.56 |

| | | | | |
|---|---|---|---|---|
| significance | NS | NS | NS | NS |

The soybean yield and content analysis of the soybeans harvested from the control plot and the plots supplemented with either BIOX-F or BIOX-EDDI are summarized in Table 38. None of the micronutrient treatments resulted in a significant increase in soybean yield, soybean protein content, or soybean oil content at either field location.

TABLE 38
Soybean yield and content of soybeans

| | | | | | Protein | | Oil | |
|---|---|---|---|---|---|---|---|---|
| | | | | | content | | content | |
| | Rate of | | Yield | | (13% | | (13% | |
| | application | Time | (Bu/A) | | moisture) | | moisture) | |
| Product | (kg/ha) | of application | F | R | F | R | F | R |
| CONTROL | — | — | 43.64 | 26.79 | 32.77 | 31.94 | 18.47 | 19.85 |
| BIOX-F | 0.558 | V4 | 43.17 | 27.92 | 32.60 | 31.93 | 18.46 | 20.12 |
| BIOX-F | 0.558 | V4, V6 | 46.01 | 27.65 | 32.73 | 32.04 | 18.42 | 20.16 |
| BIOX-F | 1.12 | V4 | 44.23 | 27.43 | 32.47 | 32.23 | 18.48 | 20.28 |
| BIOX-F | 1.12 | V4, V6 | 43.43 | 26.62 | 32.68 | 32.36 | 18.40 | 20.10 |
| BIOX-EDDI | 2.23 | V4 | 38.98 | 27.19 | 32.56 | 32.14 | 18.41 | 20.22 |
| BIOX-EDDI | 2.23 | V4, V6 | 45.28 | 24.15 | 32.58 | 31.97 | 18.56 | 19.97 |

| | | | | | | |
|---|---|---|---|---|---|---|
| significance | NS | NS | NS | NS | NS | NS |

Field site: F = Foxhome, R = Renville

### Example 12

### Effect of BIOX-M on Soybean Plants

The results of the visual greenness ratings measured from the control plot and the plots supplemented with either BIOX-M or BIOX-INM are summarized in Table 39. Significant differences in scores were recorded only at the Foxhome site at the 29 July rating. At this site, only the BIOX-M supplement provided a small but significant increase in greenness as indicated by a lower visual greenness score.

TABLE 39
Visual greenness scores for Mn-supplemented soybean plants

| | | | Mean visual | | | |
|---|---|---|---|---|---|---|
| | | | greenness scores (1-5) | | | |
| | Rate of | | Jul. 15, | | Jul. 29, | |
| | application | Time of | 2008 Rating | | 2008 Rating | |
| Product | (kg/ha) | application | Foxhome | Renville | Foxhome | Renville |
| CONTROL | — | — | 2.8 | 2.9 | 1.6 A, B | 1.6 |
| BIOX-M | 7.0 | V4 | 2.5 | 2.9 | 1.0 C | 1.3 |
| BIOX-INM | 3.27 | V4 | 3.0 | 2.4 | 1.5 A, B, C | 1.0 |

| | | | | |
|---|---|---|---|---|
| significance | NS | NS | * | NS |

The results of the ICP-MS micronutrient content analysis of the trifoliates from the control plot and the plots supplemented with either BIOX-M or BIOX-INM are summarized in Table 40. None of the micronutrient treatments resulted in a significant increase in either Fe or Mn at either field location.

TABLE 40
Micronutrient content of Mn-supplemented soybean plants

| | | | Micronutrient content | | | |
|---|---|---|---|---|---|---|
| | Rate of | | from ICP-MS analysis | | | |
| | application | Time of | Foxhome | | Renville | |
| Product | (kg/ha) | application | Mn | Fe | Mn | Fe |
| CONTROL | — | — | 88.55 | 79.73 | 97.60 | 95.26 |
| BIOX-M | 7.0 | V4 | 78.31 | 90.52 | 88.64 | 99.40 |
| BIOX-INM | 3.27 | V4 | 86.58 | 87.35 | 83.90 | 101.17 |

| | | | | |
|---|---|---|---|---|
| significance | NS | NS | NS | NS |

The soybean yield and content analysis of the soybeans harvested from the control plot and the plots supplemented with either BIOX-M or BIOX-INM are summarized in Table 41. None of the micronutrient treatments resulted in a significant increase in soybean yield, soybean protein content, or soybean oil content at either field location.

TABLE 41
Soybean yield and content of soybeans

| | | | | | Protein | | Oil | |
|---|---|---|---|---|---|---|---|---|
| | | | | | content | | content | |
| | Rate of | | Yield | | (13% | | (13% | |
| | application | Time of | (Bu/A) | | moisture) | | moisture) | |
| Treatment | (kg/ha) | application | F | R | F | R | F | R |
| CONTROL | — | — | 43.64 | 26.79 | 32.77 | 31.94 | 18.47 | 19.85 |
| BIOX-M | 7.0 | V4 | 43.63 | 24.15 | 32.90 | 31.97 | 18.28 | 19.97 |
| BIOX-INM | 3.27 | V4 | 45.05 | 27.13 | 32.63 | 32.36 | 18.32 | 19.80 |

| | | | | | | |
|---|---|---|---|---|---|---|
| significance | NS | NS | NS | NS | NS | NS |

Field site: F = Foxhome, R = Renville

### Materials and Methods for Examples 13-15

The following experiments were performed in a green house during the spring of 2009 at GCREC, Balm, University of Florida. Crop set-up, procedures and variables were as follows.

Transplants of ‘Tygress’ tomato plants were planted in 2-gallon pots filled with commercial planting medium with nutrient concentration of Fe, Zn, Mn, Cu being negligible and insufficient for crop growth. Irrigation and non-micronutrient fertilizer were provided daily through microsprinklers at recommended rates for tomato production in Florida. No pesticides were used. Treatments were as described in Tables 42, 43, and 44 below. BIOX-Cu was compared to Cu-sulfate, BIOX-EDC, and BIOX-O; and BIOX-Fe was compared to Fe-sulfate and BIOX-EDF. BIOX-MEZ is Ca-HMTBA.

TABLE 42
Cu treatments applied to tomato plants

| | |
|---|---|
| Rates of Cu | Rates of product |
| application | application |

| | | |
|---|---|---|
| Products | lb/acre/season | mg/plant |

| | | | |
|---|---|---|---|
| BIOX-Cu (17% Cu) | 0.14 | 0.8 | 83 |
| | 0.28 | 1.6 | 167 |
| | 0.46 | 2.4 | 250 |
| | 0.55 | 3.2 | 334 |
| Cu sulfate (25% Cu) | 0.8 | 3.2 | 334 |
| BIOX-EDC (15% Cu) | 0.4 | 2.7 | 281 |
| BIOX-O | 0 | 2.2 | 229 |
| CONTROL | 0 | 0 | 0 |

TABLE 43
Fe treatments applied to tomato plants

| | |
|---|---|
| Rates of Fe | Rates of product |
| application | application |

| | | |
|---|---|---|
| Products | lb/acre/season | mg/plant |

| | | | |
|---|---|---|---|
| BIOX-Fe (22.8% Fe) | 0.28 | 1.23 | 128 |
| | 0.57 | 2.5 | 261 |
| | 1.12 | 5.0 | 521 |
| | 1.74 | 7.6 | 792 |
| | 2.3 | 10.0 | 1042 |
| Fe sulfate (20% Fe) | 2.0 | 10.0 | 1042 |
| BIOX-EDF (13.1% Fe) | 0.3 | 2.3 | 240 |
| CONTROL | 0 | 0 | 0 |

TABLE 44
BIOX-MEZ treatments applied to tomato plants

Rates of product
application

| Product | lb/acre/season | mg/plant |
|---|---|---|
| BIOX-MEZ | 0.6 | 63 |
| | 1.2 | 125 |
| | 2.5 | 261 |
| | 4.8 | 504 |
| | 7.2 | 756 |
| CONTROL | 0 | 0 |

Treatments were applied at 6 WAT (weeks after transplanting) using a water volume of 200 mL/plant. Deionized water was used for foliar applications. A non-ionic surfactant was added. Other nutrients were applied as appropriate under non-limiting conditions.

Foliar tissue nutrient analysis was performed at 3 WAT (i.e., 3 weeks before treatment) and 7 WAT (i.e., 1 weeks after treatment) on the non-applied newest leaves. The concentrations of N, P, K, Mg, Ca, B, Zn, Mn, Fe, and Cu in the foliar tissue were determined by a commercial laboratory. Nutrient concentrations in the leaves at 3 WAT are shown in Table 45. There were no significant differences between the foliar nutrient concentrations of any of the treatment groups prior to treatment.

TABLE 45
Nutrient concentrations in tomato leaves 3 weeks prior to treatment

| N | P | K | Mg | Ca | B | Zn | Mn | Fe | Cu |
|---|---|---|---|---|---|---|---|---|---|
| % | | | | | ppm | | | | |
| 5.64 | 0.95 | 4.31 | 0.54 | 1.55 | 21.33 | 18.17 | 118.83 | 104..83 | 2.5 |

Marketable fruit were collected three times during the growing season, starting at 10 WAT (4 weeks after the initial treatment). Tomato fruit was graded as marketable and non-marketable. Marketable fruit was sized as extra-large, large, and medium. Non-marketable fruit were harvested and number and weight recorded but not sized.

Toxicity of the treatments was assessed by rating foliar tissue using a visual scale, where 0=no injury and 10=plant death.

Experimental design was a randomized complete block design with 6 replications. Data were analyzed using a general linear model, and means were separated using an LSD test at the 5% significance level. (Treatments with the same letters following the numerical value are not significantly different.)

### Example 13

### Effect of BIOX-Cu on Foliar Nutrient Concentration, Tomato Yield, and Foliar Toxicity

Table 46 presents the copper concentrations in tomato leaves at 7 WAT. All treatments except BIOX-O significantly increased the levels of foliar copper. The highest leaf copper concentrations were found after application of Cu-sulfate and BIOX-EDC (but as shown below, these treatments affected plant health).

TABLE 46
Cu concentrations in tomato leaves 1 week after treatment

| | Rates of Cu | Foliar Cu | |
|---|---|---|---|
| | application | concentration | |
| Products | lb/acre | ppm | |
| BIOX-Cu (17% Cu) | 0.14 | 72 | e |
| | 0.28 | 91 | e |
| | 0.46 | 208 | d |
| | 0.55 | 397 | c |
| Cu sulfate (25% Cu) | 0.8 | 986 | a |
| BIOX-EDC (15% Cu) | 0.4 | 678 | b |
| BIOX-O | 0 | 16 | f |
| CONTROL | 0 | 17 | f |

| | |
|---|---|
| Significance (P < 0.05) | * |

Treatment with BIOX-Cu at the 0.14 and 0.28 lb/acre levels significantly increased marketable tomato yields as compared to the non-treated control, as shown in Table 47. Treatment with BIOX-Cu at the 0.46 and 0.55 lb/acre levels, Cu-sulfate at 0.8 lb/acre, and BIOX-EDC at 0.4 lb/acre did not alter marketable yields relative to the non-treated control. The non-marketable yields per plant for all treatments were statistically indistinguishable from control.

TABLE 47
Yields of tomato fruits

| | Rates of Cu | Market- | Non-Marketable | |
|---|---|---|---|---|
| | application | able yield | yield | |
| Products | lb/acre | g/plant | lb/plant | no./plant |
| BIOX-Cu (17% Cu) | 0.14 | 2350 a | <0.5 | 1 |
| | 0.28 | 2500 a | <0.5 | 2 |
| | 0.46 | 1250 b | <0.5 | 2 |
| | 0.55 | 1700 b | <0.5 | 2 |
| Cu sulfate (25% Cu) | 0.8 | 1200 b | <0.5 | 2 |
| BIOX-EDC (15% Cu) | 0.4 | 1550 b | <0.5 | 2 |
| BIOX-O | 0 | 1750 b | <0.5 | 2 |
| CONTROL | 0 | 1350 b | <0.5 | 2 |

| | | | |
|---|---|---|---|
| Significance (P < 0.05) | * | NS | NS |

Plant health as a function of Cu treatment is shown in Table 48. Treatment with BIOX-Cu at the 0.46 and 0.55 lb/acre levels, Cu-sulfate at 0.8 lb/acre, and BIOX-EDC at 0.4 lb/acre had increased levels of toxicity as compared to non-treated control plants. Treatment with the two low levels of BIOX-Cu had no toxic effects.

TABLE 48
Cu Toxicity

| | Rates of Cu | |
|---|---|---|
| | application | Toxicity |
| Products | lb/acre | (0-10) |
| BIOX-Cu (17% Cu) | 0.14 | 0 |
| | 0.28 | 1 |
| | 0.46 | 5 |
| | 0.55 | 6 |
| Cu sulfate (25% Cu) | 0.8 | 6 |
| BIOX-EDC (15% Cu) | 0.4 | 6 |
| BIOX-O | 0 | 0 |
| CONTROL | 0 | 0 |

### Example 14

### Effect of BIOX-Fe on Foliar Nutrient Concentration, Tomato Yield, and Foliar Toxicity

The foliar iron concentrations in tomato leaves at 7 WAT are presented in Table 49. All treatments significantly increased foliar Fe concentration. The highest Fe concentrations were found after application of Fe-sulfate and BIOX-EDF (but as shown below, these plants displayed toxic effects).

TABLE 49
Fe concentrations in tomato leaves 1 week after treatment

| | Rates of Fe | Foliar Fe | |
|---|---|---|---|
| | application | concentration | |
| Products | lb/acre | ppm | |
| BIOX-Fe (22.8% Fe) | 0.28 | 249 | d |
| | 0.57 | 388 | c |
| | 1.12 | 517 | bc |
| | 1.74 | 453 | bc |
| | 2.3 | 383 | c |
| Fe sulfate (20% Fe) | 2.0 | 888 | a |
| BIOX-EDF (13.1% Fe) | 0.3 | 604 | b |
| CONTROL | 0 | 123 | e |

| | |
|---|---|
| Significance (P < 0.05) | * |

Treatment with BIOX-Fe at all levels resulted in significantly higher marketable tomato yields than the non-treated control, as shown in Table 50. Treatment with Fe-sulfate at 2.0 lb/acre decreased marketable yields relative to the non-treated control. Treatment with BIOX-EDF at 0.3 lb/acre did not affect the marketable yield. The non-marketable yields per plant for all treatments were statistically indistinguishable from control.

TABLE 50
Yields of tomato fruits

| | Rates of Fe | Market- | | Non-Marketable | |
|---|---|---|---|---|---|
| | application | able yield | | yield | |
| Products | lb/acre | g/plant | | lb/plant | no./plant |
| BIOX-Fe (22.8% Fe) | 0.28 | 1750 | ab | <0.5 | 1 |
| | 0.57 | 1900 | ab | <0.5 | 1 |
| | 1.12 | 2100 | ab | <0.5 | 2 |
| | 1.74 | 1900 | ab | <0.5 | 1 |
| | 2.3 | 2400 | a | <0.5 | 1 |
| Fe sulfate (20% Fe) | 2.0 | 1100 | c | <0.5 | 1 |
| BIOX-EDF(13.1% Fe) | 0.3 | 1500 | bc | <0.5 | 2 |
| CONTROL | 0 | 1350 | bc | <0.5 | 2 |

| | | | |
|---|---|---|---|
| Significance (P < 0.05) | * | NS | NS |

Table 51 presents the toxicity analysis. Plants treated with all levels of BIOX-Fe had no increased toxicity relative to the non-treated control, Treatment with Fe-sulfate at 2.0 lb/acre or BIOX-EDF at 0.3 lb/acre, however, increased toxicity.

TABLE 51
Fe Toxicity

| | Rates of FE | |
|---|---|---|
| | application | Toxicity |
| Products | lb/acre | (0-10) |
| BIOX-Fe (22.8% Fe) | 0.28 | 0 |
| | 0.57 | 0 |
| | 1.12 | 1 |
| | 1.74 | 1 |
| | 2.3 | 2 |
| Fe sulfate (20% Fe) | 2.0 | 5 |
| BIOX-EDF(13.1% Fe) | 0.3 | 5 |
| CONTROL | 0 | 0 |

### Example 15

### Effect of BIOX-MEZ on Foliar Nutrient Concentration, Tomato Yield, and Foliar Toxicity

Foliar nutrient concentrations in leaves of tomato plants treated with various concentrations of BIOX-MEZ and control plants are shown in Table 52. The levels of N, P, K, and Mg were not affected by BIOX-MEZ treatment. Foliar Ca concentration was significantly increased, however, when BIOX-MEZ was applied at a rate of 7.2 lb/acre.

TABLE 52
Nutrient concentrations in tomato leaves at 7 WAT

| | Rates of | | | | | |
|---|---|---|---|---|---|---|
| | application | | | | | |
| Products | lb/acre | N % | P % | K % | Ca % | Mg % |
| BIOX-MEZ | 0.6 | 3.8 | 0.6 | 3.8 | 1.3 b | 0.6 |
| | 1.2 | 4.2 | 0.7 | 4.4 | 1.3 b | 0.6 |
| | 2.5 | 4.4 | 0.7 | 3.9 | 1.3 b | 0.5 |
| | 4.8 | 3.8 | 0.6 | 3.9 | 1.2 b | 0.6 |
| | 7.2 | 4.7 | 0.7 | 4.6 | 1.7 a | 0.6 |
| Control | 0 | 4.5 | 0.7 | 3.8 | 1.2 b | 0.6 |

| | | | | | |
|---|---|---|---|---|---|
| Significance | NS | NS | NS | * | NA |
| (<0.05) | | | | | |

There was no change in marketable or non-marketable yields after treatment with BIOX-MEZ (see Table 53).

TABLE 53
Yields of tomato fruits

| | Rates of | Market- | Non-Marketable | |
|---|---|---|---|---|
| | application | able yield | yield | |
| Products | lb/acre | g/plant | lb/plant | no./plant |
| BIOX-MEZ | 0.6 | 1100 | <0.5 | 3 |
| | 1.2 | 875 | <0.5 | 2 |
| | 2.5 | 925 | <0.5 | 3 |
| | 4.8 | 1000 | <0.5 | 2 |
| | 7.2 | 900 | <0.5 | 3 |
| CONTROL | 0 | 800 | <0.5 | 2 |

| | | | |
|---|---|---|---|
| Significance (P < 0.05) | NS | NS | NS |

Application of BIOX-MEZ had no major toxic effects on the tomato plants (see Table 54).

TABLE 54
Toxicity

| | Rates of | |
|---|---|---|
| | application | Toxicity |
| Products | lb/acre | (0-10) |
| BIOX-MEZ | 0.6 | 0 |
| | 1.2 | 0 |
| | 2.5 | 1 |
| | 4.8 | 1 |
| | 7.2 | 1 |
| CONTROL | 0 | 0 |

1. A method for increasing a marketable yield trait of a growing plant, the method comprising administering to the growing plant at least one compound comprising a chelate of a metal and a compound of formula (I): 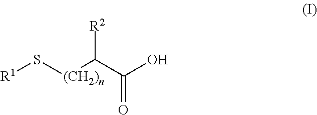
wherein:
n is an integer from 0 to 2;
R¹ is methyl or ethyl;
R² is hydroxyl or amino; and
wherein the amount of the compound administered to the growing plant increases at least one marketable yield trait of the plant without causing substantial foliar toxicity.

2. The method of claim 1, wherein n is 2, R¹ is methyl and R² is hydroxyl.

3. The method of claim 1, wherein the metal is chosen from zinc, manganese, iron, calcium, and copper.

4. The method of claim 1, wherein the compound a is chosen from Zn-HMTBA chelate, Mn-HMTBA chelate, Cu-HMTBA chelate, Ca-HMTBA chelate, and Fe-HMTBA chelate.

5. (canceled)

6. (canceled)

7. (canceled)

8. (canceled)

9. The method of claim 1, wherein the plant is chosen from a vegetable plant, a fruit plant, and a grain plant.

10. The method of claim 1, wherein at least two compounds, at least three compounds, or at least four compounds are administered to the plant.

11. (canceled)

12. The method of claim 1, wherein the compound is administered to the plant by a method chosen from foliar application, soil drip, and combinations thereof.

13. The method of claim 1, wherein the compound is further combined with a non-ionic surfactant.

14. The method of claim 1, wherein the compound is dissolved in water.

15. The method of claim 1, wherein the compound is administered with at least one other compound chosen from a fertilizer, an insecticide, an herbicide, a microbicide, a plant-growth regulator, and combinations thereof.

16. (canceled)

17. The method of claim 1, wherein the compound is administered with a sticker or a spreader.

18. (canceled)

19. The method of claim 1, wherein the application of the compound to the plant increases the foliar concentration of the metal in the plant.

20. The method of claim 1, wherein the marketable yield trait is chosen from an increase in harvestable grain, harvestable vegetables, harvestable fruits, harvestable flowers, harvestable seeds, growth of the plant, the hardiness of the plant, the color of the plant, and combinations thereof.

21. (canceled)

22. A method for providing a micronutrient to a plant, the method comprising coating a seed of the plant with at least one compound comprising a chelate of a metal and a compound of formula (I): 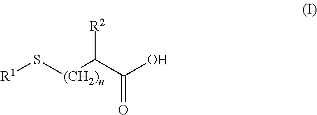
wherein:
n is an integer from 0 to 2;
R¹ is methyl or ethyl;
R² is hydroxyl or amino; and
incubating the seed under conditions such that the seed germinates, wherein the amount of the compound applied to the plant seed provides the micronutrient to the plant as it grows in a manner that is non-toxic to the plant.

23. The method of claim 22, wherein n is 2, R¹ is methyl and R² is hydroxyl.

24. The method of claim 22, wherein the metal is chosen from zinc, manganese, iron, calcium, and copper.

25. The method of claim 22, wherein the compound is chosen from Zn-HMTBA chelate, Mn-HMTBA chelate, Cu-HMTBA chelate, Ca-HMTBA chelate, and Fe-HMTBA chelate.

26. (canceled)

27. (canceled)

28. (canceled)

29. (canceled)

30. The method of claim 22, wherein the plant is chosen from a vegetable plant, a fruit plant, and a grain plant.

31. The method of claim 22, wherein at least two compounds, at least three compounds, or at least four compounds are coated on the plant seed.

32. (canceled)

33. The method of claim 22, further comprising administering to the plant at least one other compound chosen from a fertilizer, an insecticide, an herbicide, a microbicide, a plant-growth regulator, and combinations thereof.

34. (canceled)

35. The method of claim 22, wherein the foliar concentration of the metal in the plant is increased.

36. The method of claim 22, wherein at least one marketable yield trait chosen from harvestable grain, harvestable vegetables, harvestable fruits, harvestable flowers, harvestable seeds, growth of the plant, the hardiness of the plant, the color of the plant, and combinations thereof and combinations thereof is increased in the plant.

37. (canceled)

38. A method for increasing a marketable yield trait of a growing plant, the method comprising administering to the growing plant at least one compound chosen from Zn-HMTBA chelate, Mn-HMTBA chelate, Cu-HMTBA chelate, Ca-HMTBA chelate, and Fe-HMTBA chelate, wherein the amount of the compound administered to the growing plant increases at least one marketable yield trait of the plant without causing substantial foliar toxicity.

39. A composition for providing a micronutrient to a growing plant, the composition comprising at least one compound chosen from Zn-HMTBA chelate, Mn-HMTBA chelate, Cu-HMTBA chelate, Ca-HMTBA chelate, and Fe-HMTBA chelate and a carrier chosen from a non-ionic surfactant and water.

40. The composition of claim 39, further comprising at least one other compound chosen from a fertilizer, an insecticide, an herbicide, a microbicide, a plant-growth regulator, and combinations thereof.
